(19) United States
(12) Patent Application Publication
(10) Pub. No.: US 2025/0029990 A1
(43) Pub. Date: Jan. 23, 2025

(54) SECONDARY BATTERY-USE POSITIVE ELECTRODE ACTIVE MATERIAL, SECONDARY BATTERY-USE POSITIVE ELECTRODE, AND SECONDARY BATTERY

(71) Applicant: MURATA MANUFACTURING CO., LTD., Kyoto (JP)

(72) Inventors: Yukihiro KATOU, Kyoto (JP); Akiko NAGAHARA, Kyoto (JP); Gerile NAREN, Kyoto (JP); Hideki NAKAI, Kyoto (JP)

(21) Appl. No.: 18/910,732

(22) Filed: Oct. 9, 2024

Related U.S. Application Data
(63) Continuation of application No. PCT/JP2023/033952, filed on Sep. 19, 2023.

(30) Foreign Application Priority Data
Sep. 29, 2022 (JP) 2022-156258

(51) Int. Cl. H01M 4/36; H01M 4/38; H01M 4/525; H01M 10/0525; H01M 4/02

(52) U.S. Cl. CPC H01M 4/366; H01M 4/38; H01M 4/525; H01M 10/0525; H01M 2004/028

(57) ABSTRACT

A secondary battery includes a positive electrode containing a positive electrode active material, a negative electrode, and an electrolytic solution. The positive electrode active material contains a layered rock salt-type compound, and the layered rock salt-type compound contains nickel, cobalt, and aluminum as constituent elements. When a sum of contents of nickel, cobalt, and aluminum in the layered rock salt-type compound is regarded as 100 parts by mol, a content of the nickel is 87 parts by mol or more and 100 parts by mol or less, a content of the cobalt is 0 parts by mol or more and 11 parts by mol or less, and a content of the aluminum is 0 parts by mol or more and 8 parts by mol or less. In surface analysis of the positive electrode active material using X-ray photoelectron spectroscopy, a concentration ratio represented by Formula (1) is 1.60 or less and an intensity ratio represented by Formula (2) is 0.39 or less:

$$RX = X 2 / X 1 \qquad ( 1 )$$

where RX is a concentration ratio, X1 is a sum (atom %) of a concentration (atom %) of nickel calculated based on a Ni2p_{3/2} spectrum, a concentration (atom %) of cobalt calculated based on a Co2p_{3/2} spectrum, and a concentration (atom %) of aluminum calculated based on an A12s spectrum, and X2 is a concentration (atom %) of a carbonate calculated based on a C1s spectrum,

$$RY = Y 2 / Y 1 \qquad ( 2 )$$

where RY is an intensity ratio, Y1 is a peak intensity of the Ni2p_{3/2} spectrum, and Y2 is a peak intensity of a satellite spectrum derived from the Ni2p_{3/2} spectrum.

### CROSS REFERENCE TO RELATED APPLICATIONS

The present application is a continuation of PCT patent application no. PCT/JP2023/033952, filed on Sep. 19, 2023, which claims priority to Japanese patent application no. 2022-156258, filed on Sep. 29, 2022, the entire contents of which are incorporated herein by reference.

### BACKGROUND

The present technology relates to a secondary battery-use positive electrode active material, a secondary battery-use positive electrode, and a secondary battery.

Since various electronic devices such as mobile phones have been widely used, a secondary battery, which is smaller in size and lighter in weight and allows for a higher energy density, is under development as a power source. The secondary battery includes a positive electrode (secondary battery-use positive electrode), a negative electrode, and an electrolytic solution, and various considerations have been given to the configuration of the secondary battery.

For example, a positive electrode active material contains a nickel-containing lithium transition metal composite oxide, and a predetermined condition is satisfied with respect to the analysis result (presence of a specific peak and concentration of aluminum) of the positive electrode active material using hard X-ray photoelectron spectroscopy (HAXPES). A predetermined condition is satisfied with respect to the analysis result (content ratio of each constituent atom) of a positive electrode using X-ray photoelectron spectroscopy. A positive electrode active material contains Liₓ(Ni_{1-y}Co_{y})_{1-z}M_{z}O₂, and a predetermined condition is satisfied with respect to the analysis result (peak intensity ratio) of the positive electrode active material using X-ray photoelectron spectroscopy.

### SUMMARY

The present technology relates to a secondary battery-use positive electrode active material, a secondary battery-use positive electrode, and a secondary battery.

Various studies on the configuration of the secondary battery have been made, but the battery characteristics of the secondary battery are still insufficient, and therefore there is room for improvement.

A secondary battery-use positive electrode active material, a secondary battery-use positive electrode, and a secondary battery which can obtain excellent battery characteristics are desired.

A secondary battery-use positive electrode active material of an embodiment of the present technology contains a layered rock salt-type compound, and the layered rock salt-type compound contains nickel, cobalt, and aluminum as constituent elements. When a sum of contents of nickel, cobalt, and aluminum in the layered rock salt-type compound is regarded as 100 parts by mol, a content of the nickel is 87 parts by mol or more and 100 parts by mol or less, a content of the cobalt is 0 parts by mol or more and 11 parts by mol or less, and a content of the aluminum is 0 parts by mol or more and 8 parts by mol or less. In surface analysis using X-ray photoelectron spectroscopy, a concentration ratio represented by Formula (1) is 1.60 or less and an intensity ratio represented by Formula (2) is 0.39 or less:

$$RX = X 2 / X 1 \qquad ( 1 )$$

where RX is a concentration ratio, X1 is a sum (atom %) of a concentration (atom %) of nickel calculated based on a Ni2p_{3/2} spectrum, a concentration (atom %) of cobalt calculated based on a Co2p_{3/2} spectrum, and a concentration (atom %) of aluminum calculated based on an A12s spectrum, and X2 is a concentration (atom %) of a carbonate calculated based on a C1s spectrum,

$$RY = Y 2 / Y 1 \qquad ( 2 )$$

where RY is an intensity ratio, Y1 is a peak intensity of the Ni2p_{3/2} spectrum, and Y2 is a peak intensity of a satellite spectrum derived from the Ni2p_{3/2} spectrum.

A secondary battery-use positive electrode of an embodiment of the present technology contains a positive electrode active material, and the positive electrode active material has a configuration similar to the configuration of the secondary battery-use positive electrode active material of an embodiment of the present technology described above.

A secondary battery of an embodiment of the present technology includes a positive electrode, a negative electrode, and an electrolytic solution, and the positive electrode has a configuration similar to the configuration of the above-described secondary battery-use positive electrode of an embodiment of the present technology.

The “layered rock salt-type compound” is a compound having a so-called layered rock salt-type crystal structure. A detailed configuration of the layered rock salt-type compound will be described later.

According to the secondary battery-use positive electrode active material, the secondary battery-use positive electrode, or the secondary battery of an embodiment of the present technology, the secondary battery-use positive electrode active material contains the above-described layered rock salt-type compound, the concentration ratio represented by Formula (1) is 1.60 or less, and the intensity ratio represented by Formula (2) is 0.39 or less, so that excellent battery characteristics can be obtained.

The effect of the present technology is not necessarily limited to the effect described here, and may be any effect of a series of effects relating to the present technology described later.

### BRIEF DESCRIPTION OF THE FIGURES

FIG. 1 is an example of a surface analysis result of a secondary battery-use positive electrode active material in an embodiment of the present technology using X-ray photoelectron spectroscopy.

FIG. 2 is a sectional view illustrating a configuration of a secondary battery in one embodiment of the present technology.

FIG. 3 is a sectional view illustrating a configuration of a battery element illustrated in FIG. 2.

FIG. 4 is a block diagram illustrating a configuration of an application example of a secondary battery.

FIG. 5 is a sectional view illustrating a configuration of a secondary battery for a test.

### DETAILED DESCRIPTION

Hereinafter, an embodiment of the present technology will be described in further detail including with reference to drawings.

First, a secondary battery-use positive electrode active material (hereinafter, simply referred to as “positive electrode active material”) of an embodiment of the present technology will be described.

The positive electrode active material described herein is used for the secondary battery as an electrochemical device. More specifically, the positive electrode active material is used for the positive electrode as a constituent element of the secondary battery. However, the positive electrode active material may be used for other electrochemical devices which are other than the secondary battery. Specific examples of the other electrochemical devices include a primary battery and a capacitor.

The positive electrode active material occludes and releases an electrode reactant during operation of the electrochemical device (during electrode reaction). In this case, the electrode reactant is occluded and released in an ionic state.

The type of the electrode reactant is not particularly limited, but is specifically a light metal such as an alkali metal or an alkaline earth metal. Specific examples of the alkali metal include lithium, sodium, and potassium, and specific examples of the alkaline earth metal include beryllium, magnesium, and calcium.

In the following, a description is given of an example case where the electrode reactant is lithium. As a result, in the positive electrode, lithium is occluded and released in an ionic state during electrode reaction.

The positive electrode active material is a plurality of particulate materials occluding and releasing lithium ions. The particle diameter (median diameter D50 (μm)) of the positive electrode active material is not particularly limited, and can be arbitrarily set.

Specifically, the positive electrode active material contains any one kind or two or more kinds of layered rock salt-type compounds, and the layered rock salt-type compound contains nickel, cobalt, and aluminum as constituent elements.

The layered rock salt-type compound is a compound having a layered rock salt-type crystal structure as described above. Therefore, the layered rock salt-type compound is a composite oxide containing oxygen as a constituent element together with nickel, cobalt, and aluminum.

The content of nickel in the layered rock salt-type compound is sufficiently larger than the respective contents of cobalt and aluminum in the layered rock salt-type compound. Therefore, the layered rock salt-type compound described herein is a so-called highly nickel-containing layered rock salt-type compound.

Specifically, the sum of the content of nickel in the layered rock salt-type compound, the content of cobalt in the layered rock salt-type compound, and the content of aluminum in the layered rock salt-type compound is regarded as 100 parts by mol. In this case, the content of nickel in the layered rock salt-type compound is 87 parts by mol or more and 100 parts by mol or less. The content of cobalt in the layered rock salt-type compound is 0 parts by mol or more and 11 parts by mol or less. The content of aluminum in the layered rock salt-type compound is 0 parts by mol or more and 8 parts by mol or less.

As is apparent from the content of nickel described above, the layered rock salt-type compound necessarily contains nickel as a constituent element. On the other hand, as is apparent from the content of cobalt described above, the layered rock salt-type compound may contain cobalt as a constituent element, and may not contain the cobalt as a constituent element. As is apparent from the content of aluminum described above, the layered rock salt-type compound may contain aluminum as a constituent element, and may not contain the aluminum as a constituent element.

Nickel is a main constituent element, and more specifically, the content of nickel in the layered rock salt-type compound is 87 parts by mol or more because a high battery capacity can be obtained in the secondary battery using the positive electrode active material.

The layered rock salt-type compound may further contain any one kind or two or more kinds of other elements as constituent elements. The type of the other elements is not particularly limited, and specific examples thereof include titanium, zirconium, strontium, magnesium, niobium, boron, tungsten, iron, copper, chromium, vanadium, and zinc. However, the content of the other elements in the layered rock salt-type compound is preferably 1 part by mol or less. This is to secure a battery capacity.

The crystal structure (layered rock salt-type crystal structure) of the layered rock salt-type compound can be specified by analyzing the positive electrode active material using an X-ray diffraction method (XRD). The contents of nickel, cobalt, and aluminum in the layered rock salt-type compound can be measured by dissolving the positive electrode active material using an acid such as boiled hydrochloric acid to obtain a dissolved product, and then analyzing the dissolved product using high-frequency induction coupled plasma (ICP) emission spectrometry.

Here, as described above, the electrode reactant is lithium. Therefore, more specifically, the layered rock salt-type compound contains any one kind or two or more kinds of lithium composite oxides represented by Formula (3).

$${Li}_{w} {Ni}_{x} {Co}_{y} {Al}_{z} {O}_{2} \qquad ( 3 )$$

where w, x, y, and z satisfy 0.8≤w≤1.05, 0.87≤x≤1, 0≤y≤0.11, 0≤z≤0.08, and x+y+z=1.

As shown in Formula (3), the lithium composite oxide is a composite oxide containing lithium and nickel as constituent elements, and has a layered rock salt-type crystal structure. However, the lithium composite oxide may further contain one or both of cobalt and aluminum as a constituent element.

As is apparent from the range of x (0.87≤x≤1) representing the content (molar ratio) of nickel, the content of nickel in the lithium composite oxide is remarkably large. Specifically, as is apparent from the condition for x, y, and z (x+y+z=1), the content ratio of nickel in the lithium composite oxide is 87 mol % or more.

The content ratio (mol %) of nickel is a ratio of the content of nickel to the sum of the content (mol) of nickel, the content (mol) of cobalt, and the content (mol) of aluminum.

The type of the lithium composite oxide is not particularly limited, and specific examples thereof include LiNiO₂ and LiNi_{0.89}Co_{0.09}Al_{0.02}O₂.

The reason why the positive electrode active material contains the lithium composite oxide (x is 0.87 or more) is that a high battery capacity can be obtained in the secondary battery using the positive electrode active material as compared with a case where x is less than 0.87, as described above.

As described above, the lithium composite oxide may further contain any one kind or two or more kinds of other elements as constituent elements. The details of the other elements are as described above.

However, the content ratio of the other elements in the lithium composite oxide is preferably 1 mol % or less as described above. This is to secure a battery capacity. The content ratio (mol %) of the other elements is a ratio of the content (mol) of the other elements to the sum of the content (mol) of nickel, the content (mol) of cobalt, and the content (mol) of aluminum.

The positive electrode active material may further contain any one kind or two or more kinds of coating elements present at least on the surface of the layered rock salt-type compound. The coating element may be present only on the surface of the layered rock salt-type compound. Alternatively, the coating element may be present not only on the surface of the layered rock salt-type compound but also inside the layered rock salt-type compound.

The type of the coating element is not particularly limited, and specific examples of the coating element include aluminum, cerium, boron, phosphorus, zirconium, niobium, titanium, magnesium, fluorine, sulfur, silicon, strontium, and tungsten. However, the coating element may be an element not exemplified here.

When the positive electrode active material contains the coating element, the surface of the layered rock salt-type compound is electrochemically protected by using the coating element. As a result, in the secondary battery using the positive electrode active material, since a side reaction between the layered rock salt-type compound and the electrolytic solution is suppressed, deterioration of the positive electrode active material is suppressed and formation of a coating film on the surface of the positive electrode active material is also suppressed. The positive electrode active material is also suppressed from rapidly generating heat at the time of occurrence of overcharge or the like of the secondary battery.

Here, as described later, the coating element is formed on the surface of the layered rock salt-type compound by performing a coating step using a coating element-containing compound in a production step of a positive electrode active material, and thus is present at least on the surface of the layered rock salt-type compound. The details of the coating step using the coating element-containing compound will be described later.

The presence or absence and the type of the coating element can be specified by analyzing the surface of the positive electrode active material using X-ray photoelectron spectroscopy (XPS).

In order to define the physical properties of the positive electrode active material, XPS is used as a method for analyzing the surface of the positive electrode active material.

In surface analysis (elemental analysis) of the positive electrode active material using XPS, the concentration ratio RX represented by Formula (1) is 1.60 or less. The value of the concentration ratio RX is a value obtained by rounding off the value at the third decimal place.

$$RX = X 2 / X 1 \qquad ( 1 )$$

where RX is a concentration ratio, X1 is a sum (atom %) of a concentration (atom %) of nickel calculated based on a Ni2p_{3/2} spectrum, a concentration (atom %) of cobalt calculated based on a Co2p_{3/2} spectrum, and a concentration (atom %) of aluminum calculated based on an A12s spectrum, and X2 is a concentration (atom %) of a carbonate calculated based on a C1s spectrum.

As described above, the positive electrode active material (layered rock salt-type compound) contains nickel as a constituent element, and further contains one or both of cobalt and aluminum as a constituent element as necessary. Thus, when the surface of the positive electrode active material is subjected to elemental analysis using XPS, a plurality of XPS spectra (the horizontal axis represents the bond energy (eV), and the vertical axis represents the spectral intensity) are detected. Specifically, a Ni2p_{3/2} spectrum derived from nickel, a Co2p_{3/2} spectrum derived from cobalt, and an A12s spectrum derived from aluminum are detected.

An unnecessary residual alkali component is present on the surface of the positive electrode active material (layered rock salt-type compound), and the residual alkali component contains a lithium compound such as lithium carbonate (Li₂CO₃) and lithium hydroxide (LiOH). Thus, when the surface of the positive electrode active material is subjected to elemental analysis using XPS, a C1s spectrum derived from carbon as a constituent element of a carbonate (lithium carbonate) is detected.

As described later, the residual alkali component is a substance formed on the surface of the layered rock salt-type compound caused by sufficiently increasing the mixing amount of the lithium-containing compound with respect to the mixing amount of the precursor in the production step (primary firing step) of a positive electrode active material. In particular, as described above, in the case of producing a highly nickel-containing layered rock salt-type compound, since the firing temperature needs to be sufficiently lowered in the primary firing step, the residual alkali component is likely to remain on the surface of the layered rock salt-type compound without volatilizing.

In particular, the residual alkali component causes generation of an unnecessary gas in the secondary battery using the positive electrode active material, and the gas is unintentionally generated due to a side reaction between the residual alkali component and the electrolytic solution. In this case, particularly, when a highly nickel-containing layered rock salt-type compound is used as the positive electrode active material, the abundance of the residual alkali component increases. When the secondary battery in a charged state is stored in a high-temperature environment, gas is significantly likely to be generated due to the presence of lithium carbonate.

Here, when the surface of the positive electrode active material is subjected to elemental analysis using XPS, a plurality of types of C1s spectra corresponding to the chemical bond state of carbon are detected. However, since the C1s spectrum described here is a spectrum derived from a carbonate (lithium carbonate), it is a spectrum detected within a range in which the bond energy is 288 eV or more and 290 eV or less. However, depending on conditions (analysis environment) such as a base environment of a sample for analysis described later, the range of a bond energy (lower limit value and upper limit value of the bond energy) in which a spectrum derived from a carbonate is detected may slightly vary. When the C1s spectrum derived from a carbonate overlaps with another C1s spectrum derived from a substance other than the carbonate, so-called peak separation is performed to specify the C1s spectrum derived from the carbonate.

From these points, the Ni2p_{3/2} spectrum, the Co2p_{3/2} spectrum, the A12s spectrum, and the C1s spectrum are detected by analyzing the surface of the positive electrode active material using XPS. The concentration (atom %) of nickel is calculated based on the Ni2p_{3/2} spectrum, the concentration (atom %) of cobalt is calculated based on the Co2p_{3/2} spectrum, the concentration (atom %) of aluminum is calculated based on the A12s spectrum, and the concentration of carbonate is calculated based on the C1s spectrum.

As a result, the sum X1 (atom %) of the concentration of nickel, the concentration of cobalt, and the concentration of aluminum is calculated, and the concentration X2 (atom %) of carbonate is specified. Therefore, the concentration ratio RX calculated using the calculation formula (RX=X2/X1) shown in Formula (1) is 1.60 or less as described above.

The concentration ratio RX is an index indicating how much carbonate (lithium carbonate) is present with respect to the total abundance of nickel, cobalt, and aluminum on the surface of the positive electrode active material (layered rock salt-type compound). This shows a tendency that the amount of lithium carbonate increases as the value of the concentration ratio RX increases, and the amount of lithium carbonate decreases as the value of the concentration ratio RX decreases.

The reason why the concentration ratio RX is 1.60 or less is that the abundance of the residual alkali component (carbonate) is sufficiently small with respect to the total abundance of nickel, cobalt, and aluminum on the surface of the positive electrode active material. As a result, in the secondary battery using the positive electrode active material, generation of an unnecessary gas due to the presence of the residual alkali component is suppressed. In this case, particularly, when the secondary battery in a charged state is stored in a high-temperature environment, generation of gas is sufficiently suppressed.

Incidentally, for confirmation, in the description, when the layered rock salt-type compound does not contain cobalt as a constituent element, the Co2p_{3/2} spectrum is not detected, and thus the concentration of cobalt is 0 atom %. Similarly, when the layered rock salt-type compound does not contain aluminum as a constituent element, the A12s spectrum is not detected, the concentration of aluminum is 0 atom %.

In surface analysis (elemental analysis) of the positive electrode active material using XPS, the intensity ratio RY represented by Formula (2) is 0.39 or less. The value of the intensity ratio RY is a value obtained by rounding off the value at the third decimal place.

$$RY = Y 2 / Y 1 \qquad ( 2 )$$

where RY is an intensity ratio, Y1 is a peak intensity of the Ni2p_{3/2} spectrum, and Y2 is a peak intensity of a satellite spectrum derived from the Ni2p_{3/2} spectrum.

As described above, the positive electrode active material (layered rock salt-type compound) contains nickel as a constituent element. Thus, when the surface of the positive electrode active material is subjected to elemental analysis using XPS, a Ni2p_{3/2} spectrum derived from nickel is detected. In this case, not only the Ni2p_{3/2} spectrum but also other spectra (so-called satellite spectra) derived from the Ni2p_{3/2} spectrum are detected.

Specifically, when the surface of the positive electrode active material is subjected to elemental analysis using XPS to obtain the result of the elemental analysis (XPS spectrum), the Ni2p_{3/2} spectrum is a spectrum detected within a range in which the bond energy is 850 eV or more and 858 eV or less, and has a peak within the range.

The satellite spectrum is another spectrum detected on a side where the bond energy is larger than the peak position of the Ni2p_{3/2} spectrum. The satellite peak is a spectrum detected within a range in which the bond energy is larger than 858 eV and smaller than 868 eV, and has a peak within the range.

The Ni2p_{3/2} spectrum has the peak intensity Y1, and the satellite spectrum has the peak intensity Y2. The peak intensity Y2 is smaller than the peak intensity Y1. The procedure for specifying the peak intensities Y1 and Y2 will be described later.

From these points, the Ni2p_{3/2} spectrum and the satellite spectrum are detected by analyzing the surface of the positive electrode active material using XPS. As a result, the peak intensity Y1 of the Ni2p_{3/2} spectrum is specified, and the peak intensity Y2 of the satellite spectrum is specified. Therefore, the intensity ratio RY calculated using the calculation formula (RY=Y2/Y1) shown in Formula (2) is 0.39 or less as described above.

The intensity ratio RY is an index indicating the atomic state (oxidation number) of nickel present on the surface of the positive electrode active material (layered rock salt-type compound). Since the abundance of divalent nickel is larger as the value of the intensity ratio RY is larger, it shows that the abundance of trivalent nickel is smaller. Since the abundance of divalent nickel is smaller as the value of the intensity ratio RY is smaller, it shows that the abundance of trivalent nickel is larger.

The reason why the intensity ratio RY is 0.39 or less is that the abundance of trivalent nickel is sufficiently larger than the abundance of divalent nickel on the surface of the positive electrode active material. As a result, nickel oxide (NiO) serving as a resistance layer, that is, a compound of divalent nickel is hardly formed on the surface of the positive electrode active material because the positive electrode active material does not have a lithium diffusion path. Therefore, in the secondary battery using the positive electrode active material, a charge transfer reaction easily proceeds smoothly at the interface between the positive electrode and the electrolytic solution, so that the charge transfer resistance of the positive electrode is reduced.

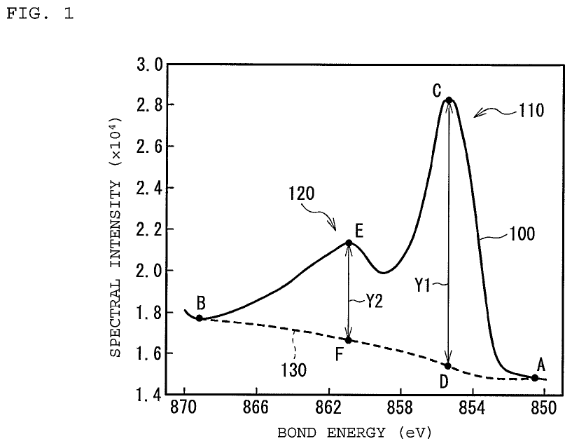

FIG. 1 shows an example of a surface analysis result of the positive electrode active material using XPS. The peak intensities Y1 and Y2 are specified using the background line 130 after the background line 130 is specified using the Shirley method as described below.

In the case of specifying the peak intensities Y1 and Y2, first, the surface analysis (elemental analysis on nickel) of the positive electrode active material is performed using XPS to obtain an XPS spectrum 100 (the horizontal axis represents the bond energy (eV), and the vertical axis represents the spectral intensity (×104)) as shown in FIG. 1.

As described above, the XPS spectrum includes a Ni2p_{3/2} spectrum 110 and a satellite spectrum 120 derived from the Ni2p_{3/2} spectrum 110. As described above, the Ni2p_{3/2} spectrum 110 is detected within a range in which the bond energy is 850 eV or more and 858 eV or less. On the other hand, the satellite spectrum 120 is detected within a range in which the bond energy is larger than 858 eV and smaller than 868 eV.

Subsequently, the background line 130 is specified for the XPS spectrum 100 including Ni2p_{3/2} spectrum 110 and the satellite spectrum 120 by using the Shirley method according to the procedure described below.

In this case, first, a bond energy E1 (eV) corresponding to the peak position of the Ni2p_{3/2} spectrum 110 is specified, and then a position on the XPS spectrum 100 corresponding to a bond energy E2 (=E1−5 eV) smaller than the bond energy E1 by 5 eV is set as a start point A. The “peak position” means a position where the spectral intensity of the Ni2p_{3/2} spectrum 110 is maximized.

Subsequently, a position on the XPS spectrum 100 corresponding to a bond energy E3 (=E1+14 eV) larger than the above-described bond energy E1 by 14 eV is set as an end point B.

Subsequently, the background line 130 is drawn from the start point A to the end point B by using the Shirley method. As is apparent from FIG. 1, the background line 130 is a curve extending from the start point A to the end point B. In FIG. 1, the background line 130 is indicated by a broken line in order to easily distinguish the XPS spectrum 100 and the background line 130 from each other.

After the background line 130 is specified, finally, a position where the spectral intensity of the Ni2p_{3/2} spectrum 110 is maximized is set as a point C, and after a bond energy corresponding to the point C is specified, a position on the background line 130 corresponding to the bond energy is set as a point D. Thus, the peak intensity Y1 is calculated by subtracting the spectral intensity corresponding to the point D from the spectral intensity corresponding to the point C.

A position where the spectral intensity of the satellite spectrum 120 is maximized is set as a point E, and after a bond energy corresponding to the point E is specified, a position on the background line 130 corresponding to the bond energy is set as a point F. Thus, the peak intensity Y2 is calculated by subtracting the spectral intensity corresponding to the point F from the spectral intensity corresponding to the point E.

As a result, since the background line 130 is specified using the Shirley method based on the XPS spectrum 100 including the Ni2p_{3/2} spectrum 110 and the satellite spectrum 120, the peak intensities Y1 and Y2 are specified using the background line 130. The function of specifying the background line 130 using the Shirley method is normally installed in a device (analyzer) performing surface analysis using XPS.

The details of the analysis procedure using XPS are as described below.

As the analyzer, an X-ray photoelectron spectrometer Quantera SXM manufactured by ULVAC-PHI, Inc. can be used. Analysis conditions are as follows: incident X-ray=monochromatized AlKα ray (1486.6 eV), analysis region=100 μmφ, and analysis depth=several nm.

In the case of performing analysis using an analyzer, the analyzer is calibrated such that a spectrum (Au4f spectrum) of a 4f orbit of a gold atom having a peak at a position where the bond energy is 84.0 eV is detected. By analyzing graphite using this calibrated analyzer, a spectrum (C1s spectrum) of a is orbit of carbon having a peak at a position where the bond energy is 284.5 eV is detected, and thus the C1s spectrum is used to correct the bond energy. In general, since surface-contaminated carbon is present on the surface of the sample for analysis, the bond energy is corrected so that the C1s spectrum of the surface-contaminated carbon having a peak at a position where the bond energy is 284.8 eV is detected, and thus the bond energy is used as a reference.

In the case of preparing a sample for analysis, a powdery positive electrode active material is sprinkled on the surface of an indium foil, and the positive electrode active material is lightly pressed against the surface of the indium foil using a spatula, and then the indium foil is attached to the surface of a sample holder using a carbon tape.

In the case of using a secondary battery in order to prepare a sample for analysis, the following procedure is used.

First, the secondary battery in a discharged state (charge rate (SOC)=0%) is disassembled to recover the positive electrode (the positive electrode current collector and the positive electrode active material layer). Subsequently, the positive electrode current collector is peeled off from the positive electrode active material layer by immersing the positive electrode in a solvent. The type of the solvent is not particularly limited, and is specifically an organic solvent such as N-methyl-2-pyrrolidone. As a result, the positive electrode active material layer containing the positive electrode active material is recovered.

Subsequently, the positive electrode active material layer is washed with a solvent. The type of the solvent is not particularly limited, and is specifically an organic solvent such as dimethyl carbonate. As a result, dissolved components such as the positive electrode binder are removed, and thus the positive electrode active material (powdery layered rock salt-type compound) as a non-dissolved component is recovered. When the non-soluble component contains not only the positive electrode active material but also the positive electrode conductive agent, the positive electrode active material may be separated from the positive electrode conductive agent using a centrifugal separation method.

Finally, the positive electrode active material is vacuum-dried, and then a sample for analysis is prepared using the positive electrode active material as described above.

The positive electrode active material is produced by performing a precursor forming step, a primary firing step, a washing step, a coating step, and a secondary firing step in this order as described below as an example of a production method.

Hereinafter, a case where the layered rock salt-type compound contains lithium, nickel, cobalt, and aluminum as constituent elements, and the positive electrode active material contains a coating material together with the layered rock salt-type compound will be described.

Here, a precursor of a positive electrode active material is formed using a coprecipitation method.

In this case, first, raw materials for forming a precursor are prepared. The raw materials are a nickel-containing compound as a supply source of nickel, a cobalt-containing compound as a supply source of cobalt, and an aluminum-containing material as a supply source of aluminum.

The nickel-containing compound is any one kind or two or more kinds of compounds containing nickel as a constituent element. The cobalt-containing compound is any one kind or two or more kinds of compounds containing cobalt as a constituent element. The aluminum-containing compound is any one kind or two or more kinds of compounds containing aluminum as a constituent element.

The type of each of the nickel-containing compound, the cobalt-containing compound, and the aluminum-containing compound is not particularly limited, and specific examples thereof include a sulfate, a carbonate, and a nitrate.

Subsequently, the nickel-containing compound, the cobalt-containing compound, and the aluminum-containing compound are charged into a solvent. The type of the solvent is not particularly limited, and is specifically any one kind or two or more kinds of water and ammonia water. In this case, the mixing ratio of the nickel-containing compound, the cobalt-containing compound, and the aluminum-containing compound is adjusted so as to form a highly nickel-containing layered rock salt-type compound in the subsequent step. As a result, the nickel-containing compound, the cobalt-containing compound, and the aluminum-containing compound are dissolved in the solvent so as to obtain a precursor solution.

Finally, the pH of the precursor solution is adjusted by titrating the precursor solution with a pH adjusting agent. The type of the pH adjusting agent is not particularly limited, but specifically, the pH adjusting agent is any one kind or two or more kinds of alkali compounds such as sodium hydroxide and lithium hydroxide. As a result, a nickel-cobalt-aluminum composite hydroxide as a coprecipitate is formed in the precursor solution. The nickel-cobalt-aluminum composite hydroxide is a hydroxide containing nickel, cobalt, and aluminum as constituent elements.

In this case, the particle diameter of the precursor can be controlled by adjusting conditions such as the reaction time of the coprecipitate in the precursor solution and the titration rate using the pH adjusting agent.

The precipitation rate of the coprecipitate may be adjusted by suppressing a rapid change in the pH of the precursor solution using a buffer. This is because the yield of the precursor is improved. The type of the buffer is not particularly limited, and specifically, the buffer is ammonium sulfate or the like.

As a result, a precursor (nickel-cobalt-aluminum composite hydroxide) is obtained.

The precursor (nickel-cobalt-aluminum composite hydroxide) is primarily fired to form a layered rock salt-type compound.

In this case, first, as a raw material, a lithium-containing compound as a supply source of lithium is prepared. The lithium-containing compound is any one kind or two or more kinds of compounds containing lithium as a constituent element. The type of the lithium-containing compound is not particularly limited, and specifically, the lithium compound is a hydroxide, a carbonate, a nitrate, or the like.

Subsequently, the precursor and the lithium-containing compound are mixed together to obtain a mixture. In this case, the mixing amount of the lithium-containing compound is sufficiently increased with respect to the mixing amount of the precursor. More specifically, the content ratio of lithium is preferably more than 1, and the content ratio of lithium is more preferably 1.03 or more. The content ratio of the lithium-containing compound is a ratio of the content (mol) of lithium to the sum of the content (mol) of nickel, the content (mol) of cobalt, and the content (mol) of aluminum.

When the content ratio of lithium is larger than 1, it is suppressed that the content ratio of lithium locally becomes smaller than 1 due to volatilization of lithium in the primary firing step. When the content ratio of lithium is smaller than 1, an inactive site (rock salt domain) is generated in the layered rock salt-type compound, which causes a decrease in electrochemical characteristics of the positive electrode active material.

When the mixing amount of the lithium-containing compound is intentionally excessive by setting the content ratio of lithium to be larger than 1, the lithium-containing compound functions as a sintering aid in the primary firing step. As a result, the crystal growth of the precursor is promoted, and the firing reaction uniformly proceeds in the primary firing step, so that the firing temperature can be set to a relatively low temperature in the primary firing step.

Finally, the mixture is fired in an oxygen atmosphere. The firing conditions such as a firing temperature and a firing time can be arbitrarily set.

In particular, the firing temperature is preferably 600° C. to 850° C. When the firing temperature is lower than 600° C., the inside of the mixture is not sufficiently fired, so that there is a possibility that the layered rock salt-type crystal structure (R3m) is not sufficiently formed. When the firing temperature is higher than 850° C., lithium is insufficient due to volatilization of lithium, so that a phenomenon in which divalent nickel is mixed into a site of lithium (so-called cation mixing) may occur. When cation mixing occurs, a rock salt domain is formed, which causes a decrease in electrochemical characteristics of the positive electrode active material.

The oxygen atmosphere is used at the time of firing the mixture in order to promote the generation of trivalent nickel. Trivalent nickel has an ionic radius different from the ionic radius of divalent nickel. Thus, trivalent nickel has a property of being less likely to be mixed in the site of lithium, unlike divalent nickel. Therefore, cation mixing is less likely to occur, so that an inert structure is hardly formed in the layered rock salt-type compound.

The oxygen concentration in the oxygen atmosphere is not particularly limited. In particular, the oxygen concentration is preferably 40 vol % or more. This is because the firing reaction easily proceeds smoothly and sufficiently in the primary firing step.

As a result, a layered rock salt-type compound is formed.

The layered rock salt-type compound is washed by performing a two-step washing step, and then the layered rock salt-type compound is dried.

The reason for using the two-step washing step for washing the layered rock salt-type compound is as described below. First, this is because the residual alkali component present on the surface of the layered rock salt-type compound is sufficiently removed. The details of the residual alkali component are as described above, and the residual alkali component contains lithium carbonate. Secondly, this is because, in the subsequent steps (the coating step and the secondary firing step), a decrease in the valence of nickel present on the surface of the layered rock salt-type compound (a change in the valence of nickel from trivalent to divalent) is suppressed.

In the primary washing step, an aqueous solvent is used as a solvent for washing (primary solvent). The type of the aqueous solvent is not particularly limited, and specifically, the aqueous solvent is pure water or the like. The primary solvent may contain an additive such as a surfactant.

Specifically, the layered rock salt-type compound is charged into the primary solvent, and then the primary solvent is stirred. The ratio of the solid content in the primary solvent is set to 50 wt % or more. The ratio of the solid content is the ratio of the weight of the layered rock salt-type compound to the weight of the primary solvent. The temperature of the primary solvent is set to 25° C. or higher, the stirring time is set to 10 minutes or shorter, and the stirring speed is set to 500 rpm or less. This is because the surface of the layered rock salt-type compound is sufficiently washed, so that the residual alkali component is sufficiently removed.

In the primary washing step, when the ratio of the solid content decreases, the temperature of the primary solvent increases, the stirring time increases, and the stirring speed increases, the layered rock salt-type compound is further washed, so that the residual alkali component is further removed.

In the primary washing step, as described above, the layered rock salt-type compound is washed by adjusting the ratio of the solid content, the temperature of the primary solvent, the stirring time, and the stirring speed, so that the residual alkali component is removed.

However, when the layered rock salt-type compound is excessively washed, lithium ions in the layered rock salt-type compound are substituted with hydrogen ions in the primary solvent (aqueous solvent), so that the abundance of lithium on the surface of the layered rock salt-type compound decreases. Therefore, in the step after the primary washing step, the valence of nickel decreases (the valence of nickel changes from trivalent to divalent).

Lithium ions substituted with hydrogen ions change to lithium hydroxide on the surface of the layered rock salt-type compound, and the lithium hydroxide changes to lithium carbonate due to reaction with carbon dioxide in the atmosphere. As a result, it is difficult to sufficiently remove the residual alkali component only by the primary washing step although the primary washing step is performed to remove the residual alkali component, and in some cases, the residual alkali component may be further increased.

That is, since the residual alkali component is water-soluble, it is considered that the washing effect on the layered rock salt-type compound is sufficient in the primary washing step using the aqueous solvent as the primary solvent. However, in the primary washing step, the contact opportunity between the layered rock salt-type compound and the aqueous solvent, that is, the possibility that lithium ions are substituted with hydrogen ions is promoted.

Therefore, the layered rock salt-type compound is washed in the primary washing step, and then the layered rock salt-type compound is further washed in the secondary washing step in order to sufficiently remove the residual alkali component and to suppress a decrease in the valence of nickel in the subsequent step by efficiently washing the layered rock salt-type compound.

In the secondary washing step, an alcohol is used as a solvent for washing (secondary solvent). The type of the alcohol is not particularly limited, and specifically, the alcohol is any one kind or two or more kinds of methanol, ethanol, and the like.

Specifically, after the primary washing step is completed, the layered rock salt-type compound is charged into the secondary solvent, and then the secondary solvent is stirred. Thereby, the layered rock salt-type compound is washed while avoiding contact of the layered rock salt-type compound with the aqueous solvent. In this case, the ratio of the solid content in the secondary solvent is set to 50 wt % or less, the temperature of the secondary solvent is set to 30° C. or higher, the stirring time is set to 60 minutes or longer, and the stirring speed is set to 800 rpm or more. This is because the surface of the layered rock salt-type compound is sufficiently washed, so that the residual alkali component is sufficiently removed.

Here, the washing ability (ability to remove the residual alkali component) of the layered rock salt-type compound in the primary washing step using the primary solvent (aqueous solvent) is higher than the washing ability of the layered rock salt-type compound in the secondary washing step using the secondary solvent (alcohol). However, when the layered rock salt-type compound is excessively washed in the primary washing step, it is substantially difficult to sufficiently remove the residual alkali component as described above.

Therefore, in order to sufficiently remove substantially the residual alkali component in the washing step, the washing strength of the layered rock salt-type compound is intentionally suppressed in the primary washing step, and the washing strength of the layered rock salt-type compound is intentionally enhanced in the secondary washing step. Thus, in the primary washing step, the ratio of the solid content in the primary solvent, the temperature of the primary solvent, the stirring time, and the stirring speed are set as described above in order to intentionally suppress the washing strength, whereas in the secondary washing step, the ratio of the solid content in the secondary solvent, the temperature of the secondary solvent, the stirring time, and the stirring speed are set as described above in order to intentionally enhance the washing strength.

In the secondary washing step, when the ratio of the solid content decreases, the temperature of the secondary solvent increases, the stirring time increases, and the stirring speed increases, the layered rock salt-type compound is further washed, so that the residual alkali component is further removed.

Thus, the layered rock salt-type compound is washed in the primary washing step to remove the residual alkali component, and then the layered rock salt-type compound is further washed in the secondary washing step to remove the residual alkali component, which cannot be removed in the primary washing step, in the secondary washing step.

After the secondary washing step is completed, the layered rock salt-type compound is vacuum-dried in a vacuum environment. The drying temperature is not particularly limited, but is specifically 100° C. to 300° C.

The amount of water in the layered rock salt-type compound after drying is not particularly limited, and specifically, the amount of water is preferably 500 ppm or less. This is because when the amount of water is larger than 500 ppm, lithium ions in the layered rock salt-type compound may be substituted with hydrogen ions in water. When the lithium ions are substituted with hydrogen ions, oxygen and water are released from the layered rock salt-type compound in the subsequent step (secondary firing step), so that the valence of nickel decreases.

The reaction formula when the valence of nickel decreases is as follows.

LiNiO₂+H₂O→NiOOH+LiOH

4NiOOH→4NiO+O₂+2H₂O

By performing the drying step, the residual alkali component is removed in the primary washing step, and not only an increase in the residual alkali component in the secondary washing step is suppressed, but also an increase in the residual alkali component in a step after the drying step is further suppressed.

In the coating step, a dry method or a wet method may be used. Hereinafter, a case where a dry method is used will be described.

A coating element-containing compound as a supply source of a coating element is prepared. The coating element-containing compound is any one kind or two or more kinds of compounds containing a coating element as a constituent element. The type of the coating element-containing compound is not particularly limited, and specifically, the coating element-containing compound is an oxide, a sulfide, or the like. Incidentally, the details of the coating element are as described above.

When the coating element-containing compound contains a tetravalent or higher coating element as a constituent element, it is preferable that the coating element-containing compound does not form a solid solution with the layered rock salt-type compound. This is because when the coating element-containing compound containing a tetravalent or higher coating element as a constituent element forms a solid solution with the layered rock salt-type compound, the valence of nickel in the layered rock salt-type compound decreases in a charge-compensating manner.

The coating element-containing compound preferably has high reactivity to the residual alkali component. This is because the coating element reacts with the residual alkali component in the subsequent step (secondary firing step), so that the residual alkali component is consumed. As an example, when the coating element is boron and the coating element-containing compound is boron oxide (B₂O₃), the reaction of B₂O₃+Li₂CO₃→2LiBO₂+CO₂ proceeds, so that the residual alkali component is consumed.

In the coating step, the layered rock salt-type compound and the coating element-containing compound are mixed together to obtain a mixture, and the mixture is stirred. The mixing ratio of the layered rock salt-type compound and the coating element-containing compound is not particularly limited, and thus can be arbitrarily set.

The environmental conditions of the coating step are not particularly limited. In particular, the dew point is preferably sufficiently low, and more specifically, the dew point is preferably −80° C. or lower. This is to suppress adhesion of unnecessary moisture to the surface of the layered rock salt-type compound in the coating step. A specific example of the environment in which the dew point is −80° C. or lower is an argon gas atmosphere in which the partial pressure of argon is 80% or more.

As a result, the coating element is fixed to the surface of the layered rock salt-type compound.

In an oxygen atmosphere, the layered rock salt-type compound in which the coating element is fixed to the surface is secondarily fired to form a positive electrode active material. The firing conditions such as a firing temperature and a firing time can be arbitrarily set.

In the secondary firing step, since the coating element is diffused on the surface of the layered rock salt-type compound, the surface of the layered rock salt-type compound is more uniformly covered with the coating element. In this case, as described above, since the coating element uniformly diffused on the surface of the layered rock salt-type compound reacts with the residual alkali component, the residual alkali component is sufficiently consumed.

In particular, in the secondary firing step, when the valence of nickel decreases on the surface of the layered rock salt-type compound before the previous step, a part of the nickel is oxidized by performing secondary firing under appropriate conditions. That is, divalent nickel is returned to trivalent nickel (layered rock salt layer of R3m) using secondary firing.

In particular, the firing temperature is preferably 300° C. to 750° C., and the firing time is preferably 3 hours to 12 hours. This is because the coating element is easily uniformly coated, so that the residual alkali component is more easily consumed. Incidentally, the details of the oxygen concentration in the oxygen atmosphere are as described above.

As a result, a positive electrode active material containing the layered rock salt-type compound and the coating element is completed.

In the method for producing a positive electrode active material described above, a precursor containing aluminum as a constituent element was formed by using an aluminum-containing compound in the precursor forming step.

However, instead of using the aluminum-containing compound in the precursor forming step, the aluminum-containing compound may be used in the primary firing step. In this case, in the precursor forming step, a precursor not containing aluminum as a constituent element is formed. In the primary firing step, a mixture containing the precursor, the lithium-containing compound, and the aluminum-containing compound is fired. Also in this case, since the layered rock salt-type compound is formed, the positive electrode active material is formed.

In the case of producing a positive electrode active material, the concentration ratio RX and the intensity ratio RY can be adjusted by changing any one kind or two or more kinds of a series of conditions described below.

Primary washing step: Ratio of solid content in primary solvent, temperature of primary solvent, stirring time, and stirring speed

Secondary washing step: Ratio of solid content in secondary solvent, temperature of secondary solvent, stirring time, and stirring speed

Coating step: Mixing ratio (weight ratio) of layered rock salt-type compound and coating element-containing material

Secondary firing step: Oxygen concentration in oxygen atmosphere, firing temperature, and firing time

That is, by changing any one kind or two or more kinds of the series of conditions described above, in the surface analysis of the positive electrode active material using XPS, the sum X1 of the concentration of nickel, the concentration of cobalt, and the concentration of aluminum changes, and the concentration X2 of carbonate changes. Therefore, the concentration ratio RX changes according to the sum X1 and the concentration X2.

By changing any one kind or two or more kinds of the series of conditions described above, in the surface analysis of the positive electrode active material using XPS, the peak intensity Y1 of the Ni2p_{3/2} spectrum 110 changes, and the peak intensity Y2 of the satellite spectrum 120 changes. Therefore, the intensity ratio RY changes according to the peak intensities Y1 and Y2.

According to the positive electrode active material, the positive electrode active material contains the above-described highly nickel-containing layered rock salt-type compound. In surface analysis of the positive electrode active material using XPS, the concentration ratio RX represented by Formula (1) is 1.60 or less and the intensity ratio RY represented by Formula (2) is 0.39 or less.

In this case, as described above, a series of actions described below can be obtained.

First, since the positive electrode active material contains a highly nickel-containing layered rock salt-type compound, a high battery capacity is obtained in the secondary battery using the positive electrode active material.

Secondly, since the concentration ratio RX is 1.60 or less, the abundance of the residual alkali component (carbonate) is sufficiently small with respect to the total abundance of nickel, cobalt, and aluminum on the surface of the positive electrode active material. As a result, in the secondary battery using the positive electrode active material, generation of an unnecessary gas due to the presence of the residual alkali component is suppressed.

Third, since the intensity ratio RY is 0.39 or less, the abundance of trivalent nickel is sufficiently larger than the abundance of divalent nickel on the surface of the positive electrode active material. As a result, a compound of divalent nickel (nickel oxide) serving as a resistance layer is hardly formed on the surface of the positive electrode active material. Therefore, in the secondary battery using the positive electrode active material, a charge transfer reaction easily proceeds smoothly at the interface between the positive electrode and the electrolytic solution, so that the charge transfer resistance of the positive electrode is reduced.

From these points, when the positive electrode active material contains a highly nickel-containing layered rock salt-type compound, in the secondary battery using the positive electrode, the charge transfer resistance of the positive electrode is reduced, and generation of an unnecessary gas is suppressed. Accordingly, a secondary battery can be achieved which has excellent battery characteristics.

In particular, when the positive electrode active material further contains the coating element present at least on the surface of the layered rock salt-type compound, the surface of the layered rock salt-type compound is electrochemically protected by using the coating element, so that a higher effect can be obtained.

A secondary battery of an embodiment of the present technology to which the positive electrode is applied will be described.

Since the secondary battery-use positive electrode of an embodiment of the present technology (hereinafter, simply referred to as “positive electrode”) is a constituent element of the secondary battery described here, the positive electrode will be also described below.

The secondary battery described herein is a secondary battery that can obtain a battery capacity by utilizing occlusion and release of an electrode reactant and includes a positive electrode, a negative electrode, and an electrolytic solution. Here, as described above, a description is given of an example case where the electrode reactant is lithium. A secondary battery in which the battery capacity is attained by utilizing occlusion and release of lithium is a so-called lithium ion secondary battery. In the lithium ion secondary battery, as described above, lithium is occluded and released in an ionic state.

A charge capacity of the negative electrode is preferably larger than a discharge capacity of the positive electrode. That is, an electrochemical capacity per unit area of the negative electrode is preferably larger than an electrochemical capacity per unit area of the positive electrode. This is to prevent lithium from precipitating on the surface of the negative electrode during charging.

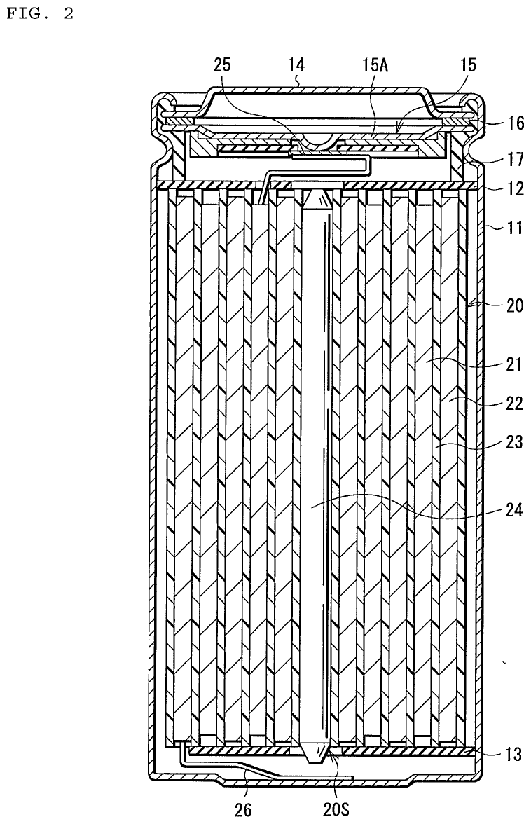

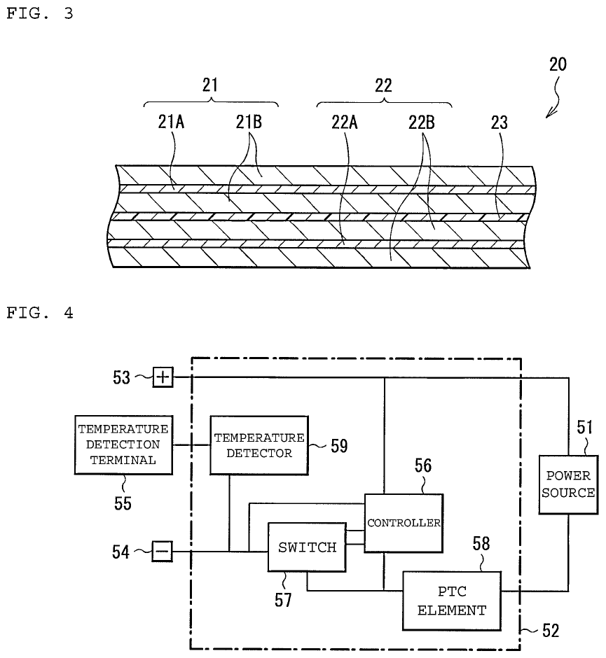

FIG. 2 illustrates a sectional configuration of a secondary battery, and FIG. 3 illustrates a sectional configuration of a battery element 20 illustrated in FIG. 2.

As illustrated in FIGS. 2 and 3, the secondary battery mainly includes a battery can 11, a pair of insulating plates 12 and 13, the battery element 20, a positive electrode lead 25, and a negative electrode lead 26. The secondary battery described herein is a so-called cylindrical secondary battery in which the battery element 20 is housed inside the battery can 11 having a cylindrical shape.

As illustrated in FIG. 2, the battery can 11 is a housing member that houses the battery element 20 and the like. Since the battery can 11 has one open end portion and the other closed end portion, the battery can 11 has a hollow structure. The battery can 11 contains any one kind or two or more kinds of metal materials such as iron, aluminum, an iron alloy, and an aluminum alloy. A metal material such as nickel may be plated on the surface of the battery can 11.

A battery cover 14, a safety valve mechanism 15, and a heat sensitive resistance element (PTC element) 16 are crimped to the open end portion of the battery can 11 with a gasket 17 interposed therebetween. The battery can 11 is thereby sealed by the battery cover 14. Here, the battery cover 14 contains the same material as the material for forming the battery can 11. The safety valve mechanism 15 and the PTC element 16 are provided inside the battery cover 14, and the safety valve mechanism 15 is electrically connected to the battery cover 14 with the PTC element 16 interposed therebetween. The gasket 17 contains an insulating material, and asphalt or the like may be applied to the surface of the gasket 17.

In the safety valve mechanism 15, when the internal pressure of the battery can 11 reaches a certain level or more due to an internal short circuit, external heating, and the like, a disk plate 15A is reversed, and thus the electrical connection between the battery cover 14 and the battery element 20 is disconnected. In order to prevent abnormal heat generation due to a large current, the electrical resistance of the PTC element 16 rises as the temperature rises.

As illustrated in FIG. 2, the insulating plates 12 and 13 are arranged in such a manner of facing each other with the battery element 20 interposed therebetween. Thus, the battery element 20 is sandwiched between the insulating plates 12 and 13.

As illustrated in FIGS. 2 and 3, the battery element 20 is a power generating element including a positive electrode 21, a negative electrode 22, a separator 23, and an electrolytic solution (not illustrated). The positive electrode 21 is the positive electrode of an embodiment of the present technology.

The battery element 20 is a so-called wound electrode body. That is, the positive electrode 21 and the negative electrode 22 are laminated on each other with the separator 23 interposed therebetween, and are wound while facing each other with the separator 23 interposed therebetween. A center pin 24 is inserted into a space 20S provided at the winding center of the battery element 20. However, the center pin 24 may be omitted.

As illustrated in FIG. 3, the positive electrode 21 includes a positive electrode current collector 21A and a positive electrode active material layer 21B.

The positive electrode current collector 21A has a pair of surfaces on which the positive electrode active material layer 21B is provided. The positive electrode current collector 21A contains a conductive material such as a metal material, and specific examples of the conductive material include aluminum.

The positive electrode active material layer 21B contains a positive electrode active material occluding and releasing lithium. Since the positive electrode active material is the above-described secondary battery-use positive electrode active material of an embodiment of the present technology, the positive electrode active material has the configuration described with respect to the secondary battery-use positive electrode active material. However, the positive electrode active material layer 21B may further contain any one kind or two or more kinds of other materials such as a positive electrode binder and a positive electrode conductive agent. A method for forming the positive electrode active material layer 21B is not particularly limited, but is specifically a coating method or the like.

Here, since the positive electrode active material layer 21B is provided on both sides of the positive electrode current collector 21A, the positive electrode 21 includes two positive electrode active material layers 21B. However, however, since the positive electrode active material layer 21B is provided only on one surface of the positive electrode current collector 21A on the side where the positive electrode 21 faces the negative electrode 22, the positive electrode 21 may include only one positive electrode active material layer 21B.

The positive electrode binder contains any one kind or two or more kinds of materials such as synthetic rubber and a polymer compound. Specific examples of the synthetic rubber include styrene-butadiene rubber, fluorine rubber, and ethylene propylene diene. Specific examples of the polymer compound include polyvinylidene fluoride, polyimide, and carboxymethyl cellulose.

The positive electrode conductive agent contains any one kind or two or more kinds of conductive materials such as a carbon material, a metal material, and a conductive polymer compound, and specific examples of the carbon material include graphite, carbon black, acetylene black, and Ketjen black.

As illustrated in FIG. 3, the negative electrode 22 includes a negative electrode current collector 22A and a negative electrode active material layer 22B.

The negative electrode current collector 22A has a pair of surfaces on which the negative electrode active material layer 22B is provided. The negative electrode current collector 22A contains a conductive material such as a metal material, and specific examples of the conductive material include copper.

The negative electrode active material layer 22B contains any one kind or two or more kinds of negative electrode active materials occluding and releasing lithium. However, the negative electrode active material layer 22B may further contain any one kind or two or more kinds of other materials such as a negative electrode binder and a negative electrode conductive agent. The method for forming the negative electrode active material layer 22B is not particularly limited, but is specifically any one kind or two or more kinds of a coating method, a gas phase method, a liquid phase method, a thermal spraying method, a firing method (sintering method), and the like.

Here, since the negative electrode active material layer 22B is provided on both surfaces of the negative electrode current collector 22A, the negative electrode 22 includes two negative electrode active material layers 22B. However, since the negative electrode active material layer 22B is provided only on one surface of the negative electrode current collector 22A on the side where the negative electrode 22 faces the positive electrode 21, the negative electrode 22 may include only one negative electrode active material layer 22B.

The type of the negative electrode active material is not particularly limited, and specific examples thereof include a carbon material, a metal-based material, and the like. This is because a high energy density can be obtained.

Specific examples of the carbon material include graphitizable carbon, non-graphitizable carbon, and graphite (natural graphite and artificial graphite).

The metal-based material is a material including any one kind or two or more kinds of metal elements and metalloid elements capable of forming an alloy with lithium as constituent elements, and specific examples of the metal elements and metalloid elements are silicon, tin, and the like. The metal-based material may be a simple substance, an alloy, a compound, a mixture of two or more thereof, or a material including two or more phases thereof. Specific examples of the metal-based material include TiSi₂ and SiOₓ (0<x≤2 or 0.2<x<1.4).

The details of the negative electrode binder are the same as the details of the positive electrode binder, and the details of the negative electrode conductive agent are the same as the details of the positive electrode conductive agent.

As illustrated in FIG. 3, the separator 23 is an insulating porous film interposed between the positive electrode 21 and the negative electrode 22, and allows lithium ions to pass therethrough while preventing contact (short circuit) between the positive electrode 21 and the negative electrode 22. The separator 23 contains a polymer compound such as polyethylene.

The electrolytic solution is a liquid electrolyte and is impregnated in each of the positive electrode 21 and the separator 23. This electrolytic solution contains a solvent and an electrolyte salt.

The solvent contains any one kind or two or more kinds of non-aqueous solvents (organic solvents), and the electrolytic solution containing the non-aqueous solvent is a so-called non-aqueous electrolytic solution.

The non-aqueous solvent is an ester, an ether, or the like, and more specifically, is a carbonic acid ester-based compound, a carboxylic acid ester-based compound, and a lactone-based compound, or the like. This is because a dissociative nature of the electrolyte salt and mobility of the ions are improved.

The carbonic acid ester-based compound is a cyclic carbonic acid ester and a chain carbonic acid ester. Specific examples of the cyclic carbonic acid ester include ethylene carbonate and propylene carbonate, and specific examples of the chain carbonic acid ester include dimethyl carbonate, diethyl carbonate, and ethyl methyl carbonate.

The carboxylic acid ester-based compound is a chain carboxylic acid ester or the like. Specific examples of the chain carboxylic acid ester include ethyl acetate, ethyl propionate, propyl propionate, and ethyl trimethylacetate.

The lactone-based compound is a lactone or the like. Specific examples of the lactone include γ-butyrolactone and γ-valerolactone.

The ethers may be 1,2-dimethoxyethane, tetrahydrofuran, 1,3-dioxolane, 1,4-dioxane, or the like.

The non-aqueous solvent is an unsaturated cyclic carbonic acid ester, a fluorinated cyclic carbonic acid ester, a sulfonic acid ester, a phosphoric acid ester, an acid anhydride, a nitrile compound, an isocyanate compound, and the like. This is because electrochemical stability of the electrolytic solution is improved.

Specific examples of the unsaturated cyclic carbonic acid ester include vinylene carbonate, vinyl ethylene carbonate, and methylene ethylene carbonate. Specific examples of the fluorinated cyclic carbonic acid ester include ethylene monofluorocarbonate and ethylene difluorocarbonate. Specific examples of the sulfonic acid ester include propane sultone and propene sultone. Specific examples of the phosphoric acid ester include trimethyl phosphate and triethyl phosphate. Specific examples of the acid anhydride include succinic anhydride, 1,2-ethanedisulfonic anhydride, and 2-sulfobenzoic anhydride. Specific examples of the nitrile compound include succinonitrile. Specific examples of the isocyanate compound include hexamethylene diisocyanate.

The electrolyte salt contains any one kind or two or more kinds of light metal salts such as lithium salts.

Specific examples of the lithium salt include lithium hexafluorophosphate (LiPF₆), lithium tetrafluoroborate (LiBF₄), lithium trifluoromethanesulfonate (LiCF₃SO₃), lithium bis(fluorosulfonyl)imide (LiN (FSO₂)₂), lithium bis(trifluoromethanesulfonyl)imide (LiN (CF₃SO₂)₂), lithium tris(trifluoromethanesulfonyl)methide (LiC(CF₃SO₂)₃), lithium bis(oxalato) borate (LiB(C₂O₄)₂), lithium monofluorophosphate (Li₂PFO₃), and lithium difluorophosphate (LiPF₂O₂). This is because a high battery capacity can be obtained.

The content of the electrolyte salt is not particularly limited, and is specifically 0.3 mol/kg to 3.0 mol/kg with respect to the solvent. This is because high ion conductivity can be obtained.

### [Positive Electrode Lead and Negative Electrode Lead]

As illustrated in FIGS. 2 and 3, the positive electrode lead 25 is connected to the positive electrode current collector 21A of the positive electrode 21 and contains a conductive material such as aluminum. The positive electrode lead 25 is electrically connected to the battery cover 14 with the safety valve mechanism 15 interposed therebetween.

As illustrated in FIGS. 2 and 3, the negative electrode lead 26 is connected to the negative electrode current collector 22A of the negative electrode 22 and contains a conductive material such as nickel. The negative electrode lead 26 is electrically connected to the battery can 11.

The secondary battery operates as follows during charging and discharging. During charging, in the battery element 20, lithium is released from the positive electrode 21, and the lithium is occluded in the negative electrode 22 with the electrolytic solution interposed therebetween. On the other hand, during discharging, in the battery element 20, lithium is released from the negative electrode 22, and the lithium is occluded in the positive electrode 21 with the electrolytic solution interposed therebetween. At the time of charge and the time of discharge, lithium is occluded and released in an ionic state.

In the case of manufacturing a secondary battery, after the positive electrode 21 and the negative electrode 22 are produced according to an exemplary procedure described below and an electrolytic solution is prepared, a secondary battery is assembled, and the stabilization treatment of the assembled secondary battery is performed.

First, a positive electrode active material, a positive electrode binder, and a positive electrode conductive agent are mixed together to form a positive electrode mixture, and then the positive electrode mixture is charged into a solvent to prepare a paste-like positive electrode mixture slurry. The solvent may be an aqueous solvent or an organic solvent. Subsequently, the positive electrode mixture slurry is applied to both sides of the positive electrode current collector 21A to form the positive electrode active material layer 21B. Finally, the positive electrode active material layer 21B may be compression-molded using a roll press machine or the like. In this case, the positive electrode active material layer 21B may be heated or compression molding may be repeated a plurality of times. As a result, since the positive electrode active material layer 21B is formed on both sides of the positive electrode current collector 21A, the positive electrode 21 is produced.

The negative electrode 22 is formed by the same procedure as the production procedure of the positive electrode 21 described above. Specifically, first, a mixture (negative electrode mixture) in which a negative electrode active material, a negative electrode binder, and a negative electrode conductive agent are mixed together is charged into a solvent to prepare a paste-like negative electrode mixture slurry. Subsequently, the negative electrode mixture slurry is applied to both sides of the negative electrode current collector 22A to form the negative electrode active material layer 22B. Thereafter, the negative electrode active material layer 22B may be compression-molded. As a result, since the negative electrode active material layer 22B is formed on both sides of the negative electrode current collector 22A, the negative electrode 22 is produced.

The electrolyte salt is charged into the solvent. As a result, the electrolyte salt is dispersed or dissolved in the solvent, thereby preparing an electrolytic solution.

First, the positive electrode lead 25 is connected to the positive electrode current collector 21A of the positive electrode 21 by a joining method such as a welding method, and the negative electrode lead 26 is connected to the negative electrode current collector 22A of the negative electrode 22 by a joining method such as a welding method. Subsequently, the positive electrode 21 and the negative electrode 22 are laminated on each other with the separator 23 interposed therebetween, and then the positive electrode 21, the negative electrode 22, and the separator 23 are wound to prepare a wound body (not illustrated) having the space 20S. This wound body has the same configuration as the configuration of the battery element 20 except that each of the positive electrode 21, the negative electrode 22, and the separator 23 is not impregnated with the electrolytic solution. Subsequently, the center pin 24 is inserted into the space 20S of the wound body.

Subsequently, the wound body is housed inside the battery can 11 together with the insulating plates 12 and 13 in a state where the wound body is sandwiched between the insulating plates 12 and 13. In this case, the positive electrode lead 25 is connected to the safety valve mechanism 15 by a joining method such as a welding method, and the negative electrode lead 26 is connected to the battery can 11 by a joining method such as a welding method. Subsequently, the wound body is impregnated with the electrolytic solution by injecting the electrolytic solution into the battery can 11. As a result, each of the positive electrode 21, the negative electrode 22, and the separator 23 is impregnated with the electrolytic solution, and thus the battery element 20 is prepared.

Finally, the battery cover 14, the safety valve mechanism 15, and the PTC element 16 are housed inside the battery can 11, and then the battery can 11 is crimped with the gasket 17 interposed therebetween. As a result, the battery cover 14, the safety valve mechanism 15, and the PTC element 16 are fixed to the battery can 11, and the battery element 20 is enclosed inside the battery can 11, so that the secondary battery is assembled.

The assembled secondary battery is charged and discharged. Various conditions such as an environmental temperature, the number of times of charge and discharge (the number of cycles), and charge and discharge conditions can be arbitrarily set. As a result, since a coating film is formed on the surface of each of the positive electrode 21 and the negative electrode 22, the state of the secondary battery is electrochemically stabilized. Thus, the secondary battery is completed.

According to the secondary battery, the positive electrode 21 contains a positive electrode active material, and the positive electrode active material has the above-described configuration. In this case, for the reasons described above, when the positive electrode active material contains a highly nickel-containing layered rock salt-type compound, the charge transfer resistance of the positive electrode 21 is reduced, and generation of an unnecessary gas is suppressed. Accordingly, excellent battery characteristics can be obtained.

Since the positive electrode 21 contains a positive electrode active material and the positive electrode active material has the above-described configuration, for the reasons described above, a secondary battery having excellent battery characteristics can be achieved.

Other actions and effects relating to the secondary battery and the positive electrode 21 are similar to the other actions and the effects relating to the positive electrode active material described above.

The configuration of the above-described secondary battery can be appropriately changed as described below according to an embodiment. However, a series of modification examples described below may be combined with each other.

The separator 23 which is a porous film was used. However, although not specifically illustrated in the drawings, a laminated type separator including a polymer compound layer may be used.

For example, the laminated type separator includes a porous film having a pair of surfaces and a polymer compound layer provided on one surface or both surfaces of the porous film. This is because the adhesive property of the separator to each of the positive electrode 21 and the negative electrode 22 is improved, so that positional displacement (winding deviation) of the battery element 20 is suppressed. Accordingly, when a decomposition reaction or the like of the electrolytic solution occurs, the swelling of the secondary battery is suppressed. The polymer compound layer contains a polymer compound such as a polyvinylidene fluoride. This is because polyvinylidene fluoride or the like is excellent in physical strength, and electrochemically stable.

One or both of the porous film and the polymer compound layer may contain a plurality of insulating particles. This is because the plurality of insulating particles promote heat dissipation at the time of heat generation of the secondary battery, thereby improving the safety (heat resistance) of the secondary battery. The plurality of insulating particles contain any one kind or two or more kinds of insulating materials such as an inorganic material and a resin material. Specific examples of the inorganic material include aluminum oxide, aluminum nitride, boehmite, silicon oxide, titanium oxide, magnesium oxide, and zirconium oxide. Specific examples of the resin material include an acrylic resin and a styrene resin.

In the case of producing a laminated type separator, a precursor solution containing a polymer compound, a solvent, and the like is prepared, and then the precursor solution is applied to one surface or both surfaces of the porous film. In this case, a plurality of insulating particles may be added to the precursor solution as necessary.

Also in the case of using the laminated type separator, lithium can move between the positive electrode 21 and the negative electrode 22, so that the same effect can be obtained. In this case, in particular, as described above, the safety of the secondary battery is suppressed, so that a higher effect can be obtained.

An electrolytic solution which was a liquid electrolyte was used. However, although not specifically illustrated in the drawing, an electrolyte layer that is a gel-like electrolyte may be used.

In the battery element 20 using an electrolyte layer, the positive electrode 21 and the negative electrode 22 are laminated on each other with the separator 23 and the electrolyte layer interposed therebetween, and the positive electrode 21, the negative electrode 22, the separator 23, and the electrolyte layer are wound. The electrolyte layer is interposed between the positive electrode 21 and the separator 23, and is interposed between the negative electrode 22 and the separator 23.

For example, the electrolyte layer contains an electrolytic solution and a polymer compound, and the electrolytic solution is held by the polymer compound. This is because leakage of the electrolytic solution is prevented. The configuration of the electrolytic solution is as described above. The polymer compound contains polyvinylidene fluoride or the like. In the case of forming an electrolyte layer, a precursor solution containing an electrolytic solution, a polymer compound, a solvent, and the like is prepared, and then the precursor solution is applied to one surface or both surfaces of each of the positive electrode 21 and the negative electrode 22.

Also in the case of using the electrolyte layer, lithium can move between the positive electrode 21 and the negative electrode 22 with the electrolyte layer interposed therebetween, so that the same effect can be obtained. In this case, in particular, as described above, leakage of the electrolytic solution is prevented, so that a higher effect can be obtained.

The application (application example) of the secondary battery is not particularly limited. The secondary battery to be used as a power source may be a main power source or an auxiliary power source in electronic devices, electric vehicles, and the like. The main power source is a power supply that is preferentially used regardless of the presence or absence of another power source. The auxiliary power source may be a power source which is used instead of the main power supply, or is a power source which is switched from the main power source.

Specific examples of the application of the secondary battery are as described below. The secondary battery can be applied to electronic devices such as a video camcorder, a digital still camera, a mobile phone, a notebook personal computer, a headphone stereo, a portable radio, and a portable information terminal. The secondary battery can be applied to storage devices such as backup power sources and memory cards. The secondary battery can be applied to power tools such as electric drills and electric saws. The secondary battery can be applied to a battery pack mounted on an electronic device or the like. The secondary battery can be applied to medical electronic devices such as pacemakers and hearing aids. The secondary battery can be applied to electric vehicles such as electric cars (including hybrid cars). The secondary battery can be applied to power storage systems such as domestic or industrial battery systems that store electric power in preparation for emergency or the like. In these applications, one secondary battery may be used, or a plurality of secondary batteries may be used.

A single battery or an assembled battery may be used in the battery pack. The electric vehicle is a vehicle which travels using the secondary battery as a power source for driving, and may be a hybrid automobile including other driving source in addition to the secondary battery. In a home electric power storage system, home electric products and the like can be used using electric power accumulated in the secondary battery as an electric power storage source.

Here, an example of application examples of the secondary batteries will be specifically described. The configurations of the application examples explained below are merely examples, and may be changed as appropriate.

FIG. 4 illustrates a block configuration of the battery pack. The battery pack to be described herein is a battery pack (so-called soft pack) including one secondary battery and is mounted on an electronic device typified by a smartphone.

The battery pack includes a power source 51 and a circuit board 52, as illustrated in FIG. 4. The circuit board 52 is connected to the power source 51, and includes a positive electrode terminal 53, a negative electrode terminal 54, and a temperature detection terminal 55.

The power source 51 includes one secondary battery. In the secondary battery, the positive electrode lead is connected to the positive electrode terminal 53, and the negative electrode lead is connected to the negative electrode terminal 54. The power source 51 can be connected to the outside via the positive electrode terminal 53 and the negative electrode terminal 54, and thus can be charged and discharged. The circuit board 52 includes a controller 56, a switch 57, a PTC element 58, and a temperature detector 59. However, the PTC element 58 may be omitted.

The controller 56 includes a central processing unit (CPU), a memory, and the like, and controls the operation of the entire battery pack. The controller 56 performs detection and control of the use state of the power source 51 as necessary.

When a voltage of the power source 51 (secondary battery) reaches an overcharge detection voltage or an overdischarge detection voltage, the controller 56 causes the switch 57 to be disconnected so that a charge current does not flow into a current path of the power source 51. The overcharge detection voltage is not particularly limited, and is specifically 4.20 V±0.05 V. The overdischarge detection voltage is not particularly limited, and is specifically 2.40 V±0.1 V.

The switch 57 includes a charge control switch, a discharge control switch, a charge diode, a discharge diode, and the like, and switches connection or disconnection between the power source 51 and an external device according to an instruction of the controller 56. The switch 57 includes a field effect transistor (MOSFET) using a metal oxide semiconductor, and the like, and the charge and discharge currents are detected based on a turn-on resistance of the switch 57.

This temperature detector 59 includes a temperature detecting element such as a thermistor. The temperature detector 59 measures the temperature of the power source 51 using the temperature detection terminal 55 and outputs the measurement result of temperature to the controller 56. The measurement result of the temperature measured by the temperature detector 59 is used, for example, in a case where the controller 56 performs charge and discharge control at the time of abnormal heat generation and in a case where the controller 56 performs a correction process at the time of calculating remaining capacity.

### EXAMPLES

Description is given on examples of the present technology according to an embodiment.

### Examples 1 to 5 and Comparative Examples 1 and 2

As described below, after a secondary battery was manufactured, battery characteristics of the secondary battery were evaluated.

### [Production of Positive Electrode Active Material]

A positive electrode active material was produced by the procedure described below. In the case of forming a precursor, a coprecipitation method was used.

### (Precursor Forming Step)

First, as raw materials, a nickel-containing compound (nickel sulfate (NiSO₄)) and a cobalt-containing compound (cobalt sulfate (CoSO₄)) were prepared. Subsequently, an aqueous solvent (pure water), a complexing agent (ammonium hydroxide (NH₄OH)), and a buffer (ammonium sulfate ((NH₄)₂SO₄)) were charged into a reaction tank equipped with a stirrer, thereby preparing a first aqueous solution.

Subsequently, a nickel-containing compound and a cobalt-containing compound were charged into an aqueous solvent (pure water), thereby preparing a second aqueous solution. In this case, the mixing ratio of the nickel-containing compound and the cobalt-containing compound was prepared so that the molar ratio was nickel:cobalt=9:1.

Subsequently, while stirring the first aqueous solution in the reaction tank, the second aqueous solution was continuously supplied to the first aqueous solution to prepare a precursor solution. In this case, the pH of the precursor solution was adjusted to 10.5 by charging a pH adjusting agent (sodium hydroxide (NaOH)) while continuously supplying the second aqueous solution into the reaction tank. The concentration of ammonium ions in the precursor solution was controlled to be constant by charging a concentration adjusting agent (ammonium hydroxide aqueous solution) into the reaction tank while continuously supplying the second aqueous solution.

As a result, a precursor (nickel-cobalt composite hydroxide) as a coprecipitate was obtained. In this case, the particles of the coprecipitate were grown while the precursor solution was stirred to adjust the particle size (median diameter D50) of the precursor (secondary particles) to 15 μm.

Finally, the precursor was washed with a solvent for washing (pure water), and then the precursor was dried.

### (Primary Firing Step)

First, as raw materials, a lithium-containing compound (lithium hydroxide monohydrate (LiOH—H₂O)) and an aluminum-containing compound (aluminum hydroxide (Al(OH)₃)) were prepared.

Subsequently, the precursor, the lithium-containing compound, and the aluminum-containing compound were mixed together to obtain a mixture. In this case, the mixing ratio of the precursor, the lithium-containing compound, and the aluminum-containing compound was adjusted so that the molar ratio was lithium:(nickel+cobalt+aluminum)=103:100.

Finally, the mixture was fired (firing temperature=750° C. and firing time=12 hours) in an oxygen atmosphere (oxygen concentration=50 vol %).

As a result, a layered rock salt-type compound (LiNi_{0.89}Co_{0.09}Al_{0.02}O₂) was obtained. The layered rock salt-type compound is a so-called highly nickel-containing layered rock salt-type compound.

### (Washing Step)

First, 20 g of the layered rock salt-type compound was charged into 20 g of a primary solvent (pure water) (the ratio of solid content=100 wt %), and then the primary solvent was stirred to wash the layered rock salt-type compound (primary washing step). In this case, the temperature of the primary solvent was set to 25° C., the stirring time was set to 5 minutes, and the stirring speed was set to 400 rpm.

Subsequently, the primary solvent was filtered using a suction filter to recover the filtered product (layered rock salt-type compound).

Subsequently, the layered rock salt-type compound was charged into 50 g of a secondary solvent (ethanol) (the ratio of solid content=40 wt %), and then the secondary solvent was stirred to wash the layered rock salt-type compound (secondary washing step). In this case, the temperature of the secondary solvent was set to 35° C., the stirring time was set to 60 minutes, and the stirring speed was set to 800 rpm.

Subsequently, the secondary solvent was filtered using a suction filter to recover the filtered product (layered rock salt-type compound).

Finally, the layered rock salt-type compound was dried (drying temperature=150° C. and drying time=6 hours) using a vacuum dryer (drying step).

### (Coating Step)

A coating element-containing material (boron oxide (B₂O₃)) was prepared. The boron oxide contains boron (B), which is a coating element, as a constituent element.

In an inert atmosphere having a low dew point (dew point=−85° C.) (argon gas atmosphere with an argon partial pressure of 99%), the layered rock salt-type compound and the coating element-containing material were mixed together to form a mixture, and then the mixture was stirred. In this case, the mixing ratio of the layered rock salt-type compound and the coating element-containing material was adjusted so that the weight ratio was the layered rock salt-type compound:the coating element-containing material=100:0.25.

As a result, the coating element was fixed to the surface of the layered rock salt-type compound.

### (Secondary Firing Step)

The layered rock salt-type compound in which the coating element was fixed to the surface was fired (firing temperature=500° C. and firing time=10 hours) in an oxygen atmosphere (oxygen concentration=70 vol %).

As a result, a positive electrode active material containing the layered rock salt-type compound and the coating element was completed.

In the case of producing a positive electrode active material, as described above, the concentration ratio RX and the intensity ratio RY were changed by changing any one kind or two or more kinds of the series of conditions in the primary washing step, the secondary washing step, the coating step, and the secondary firing step (Examples 1 to 5).

In addition, for comparison, a positive electrode active material was produced by the same procedure except that the coating step was not performed (Comparative Example 1). In this case, the same procedure was used except that the oxygen concentration in the oxygen atmosphere was changed to 30 vol %, and the firing temperature was changed to 250° C. in the secondary firing step.

For comparison, a positive electrode active material was produced by the same procedure except that the washing step and the coating step were not performed (Comparative Example 2).

After completion of the positive electrode active material, the surface analysis of the positive electrode active material was performed using XPS to examine the concentration ratio RX and the intensity ratio RY, and the results are as shown in Table 1. The procedure for specifying the concentration ratio RX and the intensity ratio RY is as described above.

### [Manufacture of Secondary Battery]

A cylindrical secondary battery (lithium ion secondary battery) illustrated in FIGS. 2 and 3 was manufactured according to the procedure described below.

### (Production of Positive Electrode)

First, 91 parts by mass of the foregoing positive electrode active material, 3 parts by mass of a positive electrode binder (polyvinylidene fluoride), and 6 parts by mass of a positive electrode conductive agent (carbon black) were mixed together to obtain a positive electrode mixture. Subsequently, the positive electrode mixture was charged into a solvent (N-methyl-2-pyrrolidone as an organic solvent), and then the solvent was stirred to prepare a paste-like positive electrode mixture slurry. Subsequently, the positive electrode mixture slurry was applied to both sides of the positive electrode current collector 21A (strip-shaped aluminum foil having a thickness of 12 μm) using a coating apparatus, and then the positive electrode mixture slurry was dried to form the positive electrode active material layer 21B. Finally, the positive electrode active material layer 21B was compression-molded using a roll press machine. Thereby, the positive electrode 21 was produced.

### (Production of Negative Electrode)

First, 93 parts by mass of a negative electrode active material, 4 parts by mass of a negative electrode binder (styrene butadiene rubber), and 3 parts by mass of a dispersant (carboxymethyl cellulose) were mixed together to obtain a negative electrode mixture. As the negative electrode active material, a mixture of 63 parts by mass of a carbon material (artificial graphite) and 30 parts by mass of a metal-based material (silicon oxide (SiO)) was used. Subsequently, the negative electrode mixture was charged into a solvent (pure water as an aqueous solvent), and then the solvent was stirred to prepare a paste-like negative electrode mixture slurry. Subsequently, the negative electrode mixture slurry was applied to both sides of the negative electrode current collector 22A (strip-shaped copper foil having a thickness of 15 μm) using a coating apparatus and then dried to form the negative electrode active material layer 22B. Finally, the negative electrode active material layer 22B was compression-molded using a roll press machine. Thereby, the negative electrode 22 was produced.

### (Preparation of Electrolytic Solution)

An electrolyte salt (lithium hexafluorophosphate (LiPF₆) as a lithium salt) was added to the solvent and then the solvent was stirred. As the solvent, a mixture of ethylene carbonate as a cyclic carbonic acid ester, diethyl carbonate as chain carbonic acid ester, and monofluoroethylene as a fluorinated cyclic carbonic acid ester was used. In this case, the mixing ratio (weight ratio) was set to ethylene carbonate:diethyl carbonate=30:70, and the content of monofluoroethylene in the electrolytic solution was set to 10 wt %. The content of the electrolyte salt was set to 1.2 mol/l (=1.2 mol/dm³) with respect to the solvent. Thereby, the electrolytic solution was prepared.

### (Assembly of Secondary Battery)

First, the positive electrode lead 25 (aluminum foil) was welded to the positive electrode current collector 21A of the positive electrode 21, and the negative electrode lead 26 (copper foil) was welded to the negative electrode current collector 22A of the negative electrode 22.

Subsequently, the positive electrode 21 and the negative electrode 22 were laminated on each other with the separator 23 (microporous polyethylene film having a thickness of 15 μm) interposed therebetween and then the positive electrode 21, the negative electrode 22, and the separator 23 were wound to form a wound body having the space 20S. Subsequently, the center pin 24 was inserted into the space 20S of the wound body.

Subsequently, the insulating plates 12 and 13 were housed inside the battery can 11 together with the wound body. In this case, the positive electrode lead 25 was welded to the safety valve mechanism 15, and the negative electrode lead 26 was welded to the battery can 11. Subsequently, the electrolytic solution was injected into the battery can 11. By this, the wound body was impregnated with the electrolytic solution, and the battery element 20 was thus produced.

Finally, the battery cover 14, the safety valve mechanism 15, and the PTC element 16 were housed inside the battery can 11, and then the battery can 11 was crimped with the gasket 17 interposed therebetween. As a result, the battery can 11 was enclosed, so that the secondary battery was assembled.

### (Stabilization of Secondary Battery)

The secondary battery was charged and discharged for one cycle in an ambient temperature environment (temperature=23° C.). During charging, constant current charging was performed at a current of 0.1 C until the voltage reached 4.2 V, and then constant voltage charging was performed at a voltage of 4.2 V until the current reached 0.05 C. During discharging, constant current discharge was performed at a current of 0.1 C until the voltage reached 3.0 V. 0.1 C refers to a current value at which the battery capacity (theoretical capacity) can be discharged in 10 hours, and 0.05 C refers to a current value at which the battery capacity can be discharged in 20 hours.

Thus, a cylindrical secondary battery was completed.

### [Manufacture of Secondary Battery for Test]

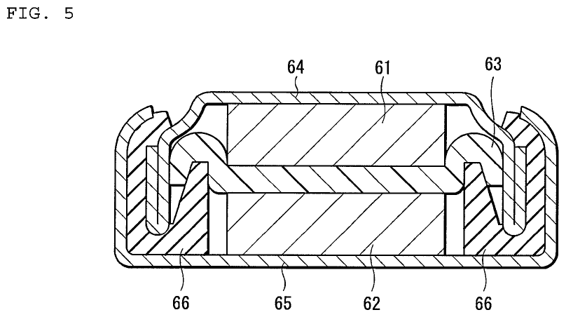

FIG. 5 illustrates a sectional configuration of a secondary battery for a test, and the secondary battery for a test is a so-called coin type secondary battery (lithium ion secondary battery). The secondary battery for a test illustrated in FIG. 5 was manufactured by the procedure described later.

### (Configuration of Secondary Battery for Test)

As illustrated in FIG. 5, the secondary battery includes a test electrode 61, a counter electrode 62, a separator 63, an exterior cup 64, an exterior can 65, a gasket 66, and an electrolytic solution (not illustrated). Here, the test electrode 61 corresponds to the positive electrode, and the counter electrode 62 corresponds to the negative electrode.

The test electrode 61 is accommodated in the exterior cup 64, and the counter electrode 62 is accommodated in the exterior can 65. The test electrode 61 and the counter electrode 62 are laminated on each other with the separator 63 interposed therebetween, and each of the test electrode 61, the counter electrode 62, and the separator 63 is impregnated with the electrolytic solution. Since the exterior cup 64 and the exterior can 65 are crimped to each other with the gasket 66 interposed therebetween, the test electrode 61, the counter electrode 62, and the separator 63 are enclosed by the exterior cup 64 and the exterior can 65.

The manufacturing procedure of the secondary battery for a test is as described below. The preparation procedure of the electrolytic solution is as described above.

### (Production of Test Electrode)

In the case of producing the test electrode 61, 95.5 parts by mass of the foregoing positive electrode active material, 1.9 parts by mass of a positive electrode binder (polyvinylidene fluoride), 2.5 parts by mass of a positive electrode conductive agent (carbon black), and 0.1 parts by mass of a dispersant (polyvinylpyrrolidone) were mixed together to obtain a positive electrode mixture. Subsequently, the positive electrode mixture was charged into a solvent (N-methyl-2-pyrrolidone as an organic solvent), and then the solvent was stirred to prepare a paste-like positive electrode mixture slurry. Subsequently, the positive electrode mixture slurry was applied to one side of the positive electrode current collector 21A (aluminum foil having a thickness of 12 μm) using a coating apparatus, and then the positive electrode mixture slurry was dried to form the positive electrode active material layer 21B. Subsequently, the positive electrode active material layer 21B was compression-molded using a roll press machine. Finally, the positive electrode current collector 21A on which the positive electrode active material layer 21B was formed was punched into a disk shape (diameter=16.5 mm). Thereby, the test electrode 61 was produced.

### (Production of Counter Electrode)

An alkali metal (lithium metal plate) as the negative electrode active material was punched into a disk shape (diameter=17 mm). Thereby, the counter electrode 62 was obtained.

### (Assembly of Secondary Battery)

First, the test electrode 61 was accommodated in the exterior cup 64, and the counter electrode 62 was accommodated in the exterior can 65. Subsequently, the test electrode 61 accommodated in the exterior cup 64 and the counter electrode 62 accommodated in the exterior can 65 were laminated on each other with the separator 63 (microporous polyethylene film having a thickness of 20 μm and a diameter of 17.5 mm) impregnated with the electrolytic solution interposed therebetween. Subsequently, in a state where the test electrode 61 and the counter electrode 62 were laminated on each other with the separator 63 interposed therebetween, the exterior cup 64 and the exterior can 65 were crimped to each other with the gasket 66 interposed therebetween. As a result, the test electrode 61 and the counter electrode 62 were enclosed in the exterior cup 64 and the exterior can 65, so that the secondary battery was assembled. Finally, the assembled secondary battery was allowed to stand still (standing time=10 hours).

Thus, a coin type secondary battery was completed.

### [Evaluation on Battery Characteristics]

As the battery characteristics, electrical resistance characteristics and gas generation characteristics were evaluated, and the results presented in Table 1 were attained.

### (Electrical Resistance Characteristics)

In the case of evaluating electrical resistance characteristics, a coin type secondary battery was used.

First, the secondary battery was charged in an ambient temperature environment (temperature=23° C.) at a current of 0.1 C until the voltage reached 4.25 V.

Subsequently, electrochemical impedance spectroscopy (EIS) measurement for the secondary battery in a charged state was performed using an impedance analyzer (AC Impedance analyzer 1255WB manufactured by Solartron Analytical) to acquire a Nyquist plot. In this case, the applied voltage, the frequency range, and the measurement temperature were set to 10 mV, 100 kHz to 0.1 Hz, and 25° C., respectively.

Finally, based on the Nyquist plot (arc on the low frequency side), the charge transfer resistance (Ω) of the test electrode 61 as an index for evaluating electrical resistance characteristics was measured.

### (Gas Generation Characteristics)

In the case of evaluating gas generation characteristics, a cylindrical secondary battery was used.

First, the secondary battery was charged in an ambient temperature environment (temperature=23° C.) at a current of 0.1 C until the voltage reached 4.2 V, and then the volume (volume (cm³) before storage) of the secondary battery was measured. Subsequently, after the secondary battery in a charged state was stored in a high-temperature environment (temperature=60° C.) (storage period=1 month), the volume (volume (cm³) after storage) of the secondary battery was measured. Finally, the gas generation amount as an index for evaluating gas generation characteristics was calculated using calculation formula: gas generation amount (cm³/g)=(volume after storage−volume before storage)/weight (g) of the positive electrode active material.

In the case of measuring the volume of the secondary battery, after the secondary battery was put into a bag-shaped laminate pack and the laminate pack was vacuum-packed, the secondary battery was cleaved inside the laminate pack, and the volume inside the laminate pack was calculated using the Archimedes method.

In the case of measuring the weight of the positive electrode active material, first, the secondary battery was disassembled to recover the positive electrode 21, and then the positive electrode 21 was immersed in a solvent (N-methyl-2-pyrrolidone as an organic solvent) (immersion time=24 hours). Subsequently, the positive electrode 21 was taken out from the solvent, and then the positive electrode active material layer 21B was peeled off from the positive electrode current collector 21A. Subsequently, the positive electrode active material layer 21B was immersed in a solvent (N-methyl-2-pyrrolidone as an organic solvent), and then ultrasonic waves were supplied to the solvent. As a result, the positive electrode binder was dissolved in the solvent, and the positive electrode active material and the positive electrode conductive agent were dispersed in the solvent.

Subsequently, the solvent was centrifuged using a centrifuge, and then the supernatant of the solvent was removed to recover the solid. Subsequently, the solid was washed a plurality of times using a solvent (N-methyl-2-pyrrolidone as an organic solvent), and then the solid was further washed a plurality of times using a solvent (dimethyl carbonate as an organic solvent). As a result, the electrolytic solution and the like adhering to the solid were removed. Finally, the solid was dried to recover the positive electrode active material, and then the weight of the positive electrode active material was measured.

TABLE 1

| | Positive electrode | | | | | |
|---|---|---|---|---|---|---|
| | active material | | | | Charge | Gas |
| | Layered rock | | | Intensity | transfer | generation |
| | salt-type | Coating | Concentration | ratio | resistance | amount |
| | compound | element | ratio RX | RY | (Ω) | (cm³/g) |
| Example 1 | LiNi_{0.89}Co_{0.09}Al_{0.02}O₂ | B | 1.56 | 0.32 | 2.0 | 1.3 |
| Example 2 | | | 0.77 | 0.35 | 4.0 | 0.9 |
| Example 3 | | | 1.60 | 0.32 | 2.0 | 1.4 |
| Example 4 | | | 0.08 | 0.38 | 6.0 | 0.6 |
| Example 5 | | | 0.07 | 0.39 | 6.5 | 0.5 |
| Comparative | | | 0.17 | 0.40 | 9.0 | 0.5 |
| Example 1 | | | | | | |
| Comparative | | | 2.85 | 0.31 | 2.0 | 2.5 |
| Example 2 | | | | | | |

As shown in Table 1, in the secondary battery in which the positive electrode active material contained a highly nickel-containing layered rock salt-type compound, the charge transfer resistance and the gas generation amount varied depending on the physical properties of the positive electrode active material.

Specifically, there is a tendency that the gas generation amount increases as the concentration ratio RX increases, and the gas generation amount decreases as the concentration ratio RX decreases. There is a tendency that the charge transfer resistance increases as the intensity ratio RY increases, and the charge transfer resistance decreases as the intensity ratio RY decreases.

In such a situation, when the appropriate condition that the concentration ratio RX is 1.60 or less and the intensity ratio RY is 0.39 or less was not satisfied (Comparative Examples 1 and 2), the gas generation amount decreased but the charge transfer resistance increased, or the charge transfer resistance decreased but the gas generation amount increased.

On the other hand, when the appropriate condition was satisfied with respect to the concentration ratio RX and the intensity ratio RY (Examples 1 to 5), the charge transfer resistance decreased and the gas generation amount also decreased. In this case, particularly, when the positive electrode active material contained a coating element together with the layered rock salt-type compound, the charge transfer resistance sufficiently decreased, and the gas generation amount also sufficiently decreased.

From the results shown in Table 1, when the positive electrode active material contained a highly nickel-containing layered rock salt-type compound, the concentration ratio RX was 1.60 or less, and the intensity ratio RY was 0.39 or less, the charge transfer resistance decreased, and the gas generation amount also decreased. Therefore, since the electrical resistance characteristics were improved and the gas generation characteristics were also improved, excellent battery characteristics were obtained in the secondary battery.

Although the present technology has been described above with reference to the embodiment and the examples, the configurations of the present technology are not limited to the configurations described in the embodiment and the examples, and are therefore modifiable in a variety of ways.

For example, a case where the battery structure of the secondary battery is a cylindrical type and a coin type has been described. However, the battery structure of the secondary battery is not particularly limited, and thus may be a laminate film type, a square type, a button type, and the like.

A case where the element structure of the battery element is a winding type has been described. However, the element structure of the battery element is not particularly limited, and may be a laminated type, a zigzag folded type, or the like. In the laminated type, the positive electrode and the negative electrode are laminated on each other, and in the zigzag folded type, the positive electrode and the negative electrode are folded in a zigzag manner.

A case where the electrode reactant is lithium has been described, but the electrode reactant is not particularly limited. Specifically, as described above, the electrode reactant may be other alkali metals such as sodium and potassium, or alkaline earth metals such as beryllium, magnesium, and calcium. In addition, the electrode reactant may be another light metal such as aluminum.

Since the effects described in the present specification are merely examples, the effects of the present technology are not limited to the effects described in the present specification. Therefore, other effects regarding the present technology may be obtained.

The present technology may also take the following configurations according to an embodiment.

<1>

A secondary battery including:
a positive electrode containing a positive electrode active material;
a negative electrode; and
an electrolytic solution,
in which the positive electrode active material contains a layered rock salt-type compound,
the layered rock salt-type compound contains nickel, cobalt, and aluminum as constituent elements,
when a sum of contents of the nickel, the cobalt, and the aluminum in the layered rock salt-type compound is regarded as 100 parts by mol,
a content of the nickel is 87 parts by mol or more and 100 parts by mol or less,
a content of the cobalt is 0 parts by mol or more and 11 parts by mol or less,
a content of the aluminum is 0 parts by mol or more and 8 parts by mol or less, and
in surface analysis of the positive electrode active material using X-ray photoelectron spectroscopy, a concentration ratio represented by Formula (1) is 1.60 or less and an intensity ratio represented by Formula (2) is 0.39 or less:

$$RX = X 2 / X 1 \qquad ( 1 )$$

where RX is a concentration ratio, X1 is a sum (atom %) of a concentration (atom %) of nickel calculated based on a Ni2p_{3/2} spectrum, a concentration (atom %) of cobalt calculated based on a Co2p_{3/2} spectrum, and a concentration (atom %) of aluminum calculated based on an A12s spectrum, and X2 is a concentration (atom %) of a carbonate calculated based on a C1s spectrum,

$$RY = Y 2 / Y 1 \qquad ( 2 )$$

where RY is an intensity ratio, Y1 is a peak intensity of the Ni2p_{3/2} spectrum, and Y2 is a peak intensity of a satellite spectrum derived from the Ni2p_{3/2} spectrum.
   <2>

The secondary battery according to <1>, in which
the positive electrode active material further contains a coating element present at least on a surface of the layered rock salt-type compound, and
the coating element includes at least one of aluminum, cerium, boron, phosphorus, zirconium, niobium, titanium, magnesium, fluorine, sulfur, silicon, strontium, and tungsten.
   <3>

The secondary battery according to <1> or <2>, which is a lithium ion secondary battery.

<4>

A secondary battery-use positive electrode containing a positive electrode active material, in which
the positive electrode active material contains a layered rock salt-type compound,
the layered rock salt-type compound contains nickel, cobalt, and aluminum as constituent elements,
when a sum of contents of the nickel, the cobalt, and the aluminum in the layered rock salt-type compound is regarded as 100 parts by mol,
a content of the nickel is 87 parts by mol or more and 100 parts by mol or less,
a content of the cobalt is 0 parts by mol or more and 11 parts by mol or less,
a content of the aluminum is 0 parts by mol or more and 8 parts by mol or less, and
in surface analysis of the positive electrode active material using X-ray photoelectron spectroscopy, a concentration ratio represented by Formula (1) is 1.60 or less and an intensity ratio represented by Formula (2) is 0.39 or less:

$$RX = X 2 / X 1 \qquad ( 1 )$$

where RX is a concentration ratio, X1 is a sum (atom %) of a concentration (atom %) of nickel calculated based on a Ni2p_{3/2} spectrum, a concentration (atom %) of cobalt calculated based on a Co2p_{3/2} spectrum, and a concentration (atom %) of aluminum calculated based on an A12s spectrum, and X2 is a concentration (atom %) of a carbonate calculated based on a C1s spectrum,

$$RY = Y 2 / Y 1 \qquad ( 2 )$$

where RY is an intensity ratio, Y1 is a peak intensity of the Ni2p_{3/2} spectrum, and Y2 is a peak intensity of a satellite spectrum derived from the Ni2p_{3/2} spectrum.
   <5>

A secondary battery-use positive electrode active material containing a layered rock salt-type compound, in which
the layered rock salt-type compound contains nickel, cobalt, and aluminum as constituent elements,
when a sum of contents of the nickel, the cobalt, and the aluminum in the layered rock salt-type compound is regarded as 100 parts by mol,
a content of the nickel is 87 parts by mol or more and 100 parts by mol or less,
a content of the cobalt is 0 parts by mol or more and 11 parts by mol or less,
a content of the aluminum is 0 parts by mol or more and 8 parts by mol or less, and
in surface analysis using X-ray photoelectron spectroscopy, a concentration ratio represented by Formula (1) is 1.60 or less and an intensity ratio represented by Formula (2) is 0.39 or less:

$$RX = X 2 / X 1 \qquad ( 1 )$$

where RX is a concentration ratio, X1 is a sum (atom %) of a concentration (atom %) of nickel calculated based on a Ni2p_{3/2} spectrum, a concentration (atom %) of cobalt calculated based on a Co2p_{3/2} spectrum, and a concentration (atom %) of aluminum calculated based on an A12s spectrum, and X2 is a concentration (atom %) of a carbonate calculated based on a C1s spectrum,

$$RY = Y 2 / Y 1 \qquad ( 2 )$$

where RY is an intensity ratio, Y1 is a peak intensity of the Ni2p_{3/2} spectrum, and Y2 is a peak intensity of a satellite spectrum derived from the Ni2p_{3/2} spectrum.

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A secondary battery comprising:
a positive electrode containing a positive electrode active material;
a negative electrode; and
an electrolytic solution,
wherein the positive electrode active material contains a layered rock salt-type compound,
the layered rock salt-type compound contains nickel, cobalt, and aluminum as constituent elements,
when a sum of contents of the nickel, the cobalt, and the aluminum in the layered rock salt-type compound is regarded as 100 parts by mol,
a content of the nickel is 87 parts by mol or more and 100 parts by mol or less,
a content of the cobalt is 0 parts by mol or more and 11 parts by mol or less,
a content of the aluminum is 0 parts by mol or more and 8 parts by mol or less, and
in surface analysis of the positive electrode active material using X-ray photoelectron spectroscopy, a concentration ratio represented by Formula (1) is 1.60 or less and an intensity ratio represented by Formula (2) is 0.39 or less:
$$RX = X 2 / X 1 \qquad ( 1 )$$
where RX is a concentration ratio, X1 is a sum (atom %) of a concentration (atom %) of nickel calculated based on a Ni2p_{3/2} spectrum, a concentration (atom %) of cobalt calculated based on a Co2p_{3/2} spectrum, and a concentration (atom %) of aluminum calculated based on an A12s spectrum, and X2 is a concentration (atom %) of a carbonate calculated based on a C1s spectrum,
$$RY = Y 2 / Y 1 \qquad ( 2 )$$
where RY is an intensity ratio, Y1 is a peak intensity of the Ni2p_{3/2} spectrum, and Y2 is a peak intensity of a satellite spectrum derived from the Ni2p_{3/2} spectrum.

2. The secondary battery according to claim 1, wherein
the positive electrode active material further contains a coating element present at least on a surface of the layered rock salt-type compound, and
the coating element includes at least one of aluminum, cerium, boron, phosphorus, zirconium, niobium, titanium, magnesium, fluorine, sulfur, silicon, strontium, and tungsten.

3. The secondary battery according to claim 1, which is a lithium ion secondary battery.

4. A secondary battery-use positive electrode comprising a positive electrode active material, wherein
the positive electrode active material contains a layered rock salt-type compound,
the layered rock salt-type compound contains nickel, cobalt, and aluminum as constituent elements,
when a sum of contents of the nickel, the cobalt, and the aluminum in the layered rock salt-type compound is regarded as 100 parts by mol,
a content of the nickel is 87 parts by mol or more and 100 parts by mol or less,
a content of the cobalt is 0 parts by mol or more and 11 parts by mol or less,
a content of the aluminum is 0 parts by mol or more and 8 parts by mol or less, and
in surface analysis of the positive electrode active material using X-ray photoelectron spectroscopy, a concentration ratio represented by Formula (1) is 1.60 or less and an intensity ratio represented by Formula (2) is 0.39 or less:
$$RX = X 2 / X 1 \qquad ( 1 )$$
where RX is a concentration ratio, X1 is a sum (atom %) of a concentration (atom %) of nickel calculated based on a Ni2p_{3/2} spectrum, a concentration (atom %) of cobalt calculated based on a Co2p_{3/2} spectrum, and a concentration (atom %) of aluminum calculated based on an A12s spectrum, and X2 is a concentration (atom %) of a carbonate calculated based on a C1s spectrum,
$$RY = Y 2 / Y 1 \qquad ( 2 )$$
where RY is an intensity ratio, Y1 is a peak intensity of the Ni2p_{3/2} spectrum, and Y2 is a peak intensity of a satellite spectrum derived from the Ni2p_{3/2} spectrum.

5. A secondary battery-use positive electrode active material comprising a layered rock salt-type compound, wherein
the layered rock salt-type compound contains nickel, cobalt, and aluminum as constituent elements,
when a sum of contents of the nickel, the cobalt, and the aluminum in the layered rock salt-type compound is regarded as 100 parts by mol,
a content of the nickel is 87 parts by mol or more and 100 parts by mol or less,
a content of the cobalt is 0 parts by mol or more and 11 parts by mol or less,
a content of the aluminum is 0 parts by mol or more and 8 parts by mol or less, and
in surface analysis using X-ray photoelectron spectroscopy, a concentration ratio represented by Formula (1) is 1.60 or less and an intensity ratio represented by Formula (2) is 0.39 or less:
$$RX = X 2 / X 1 \qquad ( 1 )$$
where RX is a concentration ratio, X1 is a sum (atom %) of a concentration (atom %) of nickel calculated based on a Ni2p_{3/2} spectrum, a concentration (atom %) of cobalt calculated based on a Co2p_{3/2} spectrum, and a concentration (atom %) of aluminum calculated based on an A12s spectrum, and X2 is a concentration (atom %) of a carbonate calculated based on a Cis spectrum,
$$RY = Y 2 / Y 1 \qquad ( 2 )$$
where RY is an intensity ratio, Y1 is a peak intensity of the Ni2p_{3/2} spectrum, and Y2 is a peak intensity of a satellite spectrum derived from the Ni2p_{3/2} spectrum.
